(19) United States
(12) Patent Application Publication
(10) Pub. No.: US 2013/0321736 A1
(43) Pub. Date: Dec. 5, 2013

(54) LIQUID CRYSTAL DISPLAY

(71) Applicant: SAMSUNG DISPLAY CO., LTD., Yongin-City (KR)

(72) Inventors: Eun Je JANG, Hwaseong-si (KR); Hyun Wuk KIM, Yongin-si (KR); Ock Soo SON, Seoul (KR); Yeon-Mun JEON, Hwaseong-si (KR); Woong Ki JEON, Dongnae-gu (KR); Yeon-Sik HAM, Suwon-si (KR)

(73) Assignee: SAMSUNG DISPLAY CO., LTD., Yongin-City (KR)

(21) Appl. No.: 13/834,604

(22) Filed: Mar. 15, 2013

(30) Foreign Application Priority Data
Jun. 5, 2012 (KR) 10-2012-0060268

(51) Int. Cl. G02F 1/1362

(52) U.S. Cl. CPC G02F 1/136286
USPC 349/46; 349/138

(57) ABSTRACT

A liquid crystal display according to the invention includes: a first insulation substrate; a common voltage line disposed on the first insulation substrate and including a plurality of expansions; an insulating layer disposed on the common voltage, where a contact hole is defined in the insulating layer; a common electrode disposed on the insulating layer; a second insulation substrate disposed opposite to the first insulation substrate; and a spacer disposed between the first insulation substrate and the second insulation substrate, where each of the expansions of the common voltage line overlaps one of the contact hole and the spacer.

This application claims priority to Korean Patent Application No. 10-2012-0060268 filed on Jun. 5, 2012, and all the benefits accruing therefrom under 35 U.S.C. §119, the content of which in its entirety is herein incorporated by reference.

### BACKGROUND

(a) Field

Exemplary embodiments of the invention relate to a liquid crystal display.

(b) Description of the Related Art

Liquid crystal displays (“LCD”s) are one of the most widely used types of a flat panel display, and LCDs display images by applying voltages to field-generating electrodes to generate an electric field in a liquid crystal (“LC”) layer that determines orientations of LC molecules therein to adjust polarization of incident light.

An LCD is typically thin sized and has light weight, while lateral visibility of the LCD may be lower than front visibility. Accordingly, liquid crystal arrangements and driving methods of various types have been developed to improve the lateral visibility of the LCD. In recent, a liquid crystal display forming a pixel electrode and a reference electrode on one substrate has been spotlighted to realize a wide viewing angle.

In the LCD, a contact hole is typically formed at an insulating layer to connect a common voltage line, which transmits a common voltage to a common electrode, to the common electrode.

In the LCD, an upper panel and a lower panel of the liquid crystal display may be supported by a spacer disposed between two panels to maintain a cell gap therebetween, and the spacer may be covered by an opaque member to effectively prevent light leakage due to the spacer.

In the LCD, the aperture ratio of the liquid crystal display may be deteriorated by the opaque member that covers the contact hole of the insulating layer and the spacer.

### SUMMARY

Exemplary embodiments of the invention relate to a liquid crystal display, in which a common voltage line that transmits a common voltage to a common electrode is electrically connected to the common electrode, a cell gap between an upper panel and a lower panel is substantially uniform, and deterioration of an aperture ratio is substantially minimized.

An exemplary embodiment of a liquid crystal display according to the invention includes: a first insulation substrate; a common voltage line disposed on the first insulation substrate and including a plurality of expansions; an insulating layer disposed on the common voltage, where a contact hole is defined in the insulating layer; a common electrode disposed on the insulating layer; a second insulation substrate disposed opposite to the first insulation substrate; and a spacer disposed between the first insulation substrate and the second insulation substrate, where each of the expansions of the common voltage line overlaps one of the contact hole and the spacer.

In an exemplary embodiment, the common electrode may be connected to the common voltage line through the contact hole.

In an exemplary embodiment, liquid crystal display may further include a pixel electrode overlapping the common electrode when viewed from a top view.

In an exemplary embodiment, at least one of the common electrode and the pixel electrode may include a plurality of branch electrodes.

Another exemplary embodiment of a liquid crystal display according to the invention includes: a first insulation substrate; a plurality of pixel electrodes disposed on the first insulation substrate substantially in a matrix form including a plurality of pixel rows and a plurality of pixel columns; a first data line extending in a second direction; a second data line extending in the second direction and disposed adjacent to the first data line, where the pixel electrodes in two pixel columns are disposed between the first data line and the second data line; a common voltage line extending in the second direction and disposed between the two pixel columns disposed between the first data line and the second data line, where the common voltage line comprises a plurality of expansions; a common electrode overlapping a plurality of pixel electrodes when viewed from a top view; an insulating layer disposed between the common voltage line and the common electrode, where a common contact hole is defined in the insulating layer; a second insulation substrate disposed opposite to the first insulation substrate; and a spacer disposed between the first insulation substrate and the second insulation substrate, where each of the expansions of the common voltage line overlaps one of the common contact hole and the spacer.

In an exemplary embodiment, the common electrode may be connected to the common voltage line through the common contact hole.

In an exemplary embodiment, the common electrode line may be disposed in a same layer as the first data line and the second data line.

In an exemplary embodiment, the first gate line may include a vertical portion extending therefrom substantially in the second direction, the second gate line may include a vertical portion extending therefrom substantially in the second direction, and an expansion of the expansions of the common voltage line may be disposed between the vertical portion of the first gate line and the vertical portion of the second gate line.

In an exemplary embodiment, one of two pixel electrodes, between which the common voltage line interposed, may be connected to the first drain electrode through a first drain contact hole defined in the insulating layer, the other of the two pixel electrodes may be connected to the second drain electrode through a second drain contact hole defined in the insulating layer, and the first drain contact hole and the second drain contact hole may be reversely symmetrical with reference to the spacer.

In an exemplary embodiment, the spacer may overlap at least a portion of a first drain contact hole and a second drain contact hole when viewed from a side view in the first direction.

In an exemplary embodiment, the common electrode line may be disposed in a same layer as the first data line and the second data line.

In one or more exemplary embodiment of the liquid crystal display according to the invention, a contact hole for the electrical connection of the common voltage line and the common electrode is provided in a pixel area of a plurality of pixel areas, and the spacer to maintain the cell gap is disposed in another pixel area of the pixel areas at a position corresponding to the contact hole of the pixel area while the contact is not formed therein such that an additional opaque member to cover the spacer is not necessary. In such embodiments, the deterioration of the aperture ratio of the liquid crystal display is effectively prevented while electrically connecting the common voltage line transmitting the common voltage to the common electrode and substantially uniformly maintaining the cell gap between the upper substrate and the lower substrate.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram showing an arrangement of a signal line and a pixel of an exemplary embodiment of a liquid crystal display according to the invention;

FIG. 2 is a top plan view of a pixel of an exemplary embodiment of a liquid crystal display according to the invention;

FIG. 3 is a cross-sectional view taken along III-III of the liquid crystal display of FIG. 2;

FIG. 4 is a cross-sectional view taken along IV-IV of the liquid crystal display of FIG. 2;

FIG. 5A and FIG. 5B are top plan views of portions of an exemplary embodiment of a liquid crystal display according to the invention;

FIG. 6 is a top plan view of pixels of an alternative exemplary embodiment of a liquid crystal display according to the invention;

FIG. 7 is a top plan view of pixels of another alternative exemplary embodiment of a liquid crystal display according to the invention;

FIG. 8 is a cross-sectional view taken along VIII-VIII of the liquid crystal display of FIG. 7;

FIG. 9 is a cross-sectional view taken along IX-IX of the liquid crystal display of FIG. 7;

FIG. 10 is a top plan view of pixels of another alternative exemplary embodiment of a liquid crystal display according to the invention;

FIG. 11 is a cross-sectional view taken along XI-XI of the liquid crystal display of FIG. 10;

FIG. 12 is a cross-sectional view display taken along XII-XII of the liquid crystal of FIG. 10;

FIG. 13 is a top plan view of pixels of another alternative exemplary embodiment of a liquid crystal display according to the invention;

FIG. 14 is a cross-sectional view taken along XIV-XIV of the liquid crystal display of FIG. 13;

FIG. 15 is a cross-sectional view taken along XV-XV of the liquid crystal display of FIG. 13;

FIG. 16 is a top plan view of pixels of another alternative exemplary embodiment of a liquid crystal display according to the invention; and

FIG. 17 is a top plan view of pixels of another alternative exemplary embodiment of a liquid crystal display according to the invention.

### DETAILED DESCRIPTION

The invention will be described more fully hereinafter with reference to the accompanying drawings, in which exemplary embodiments of the invention are shown.

This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

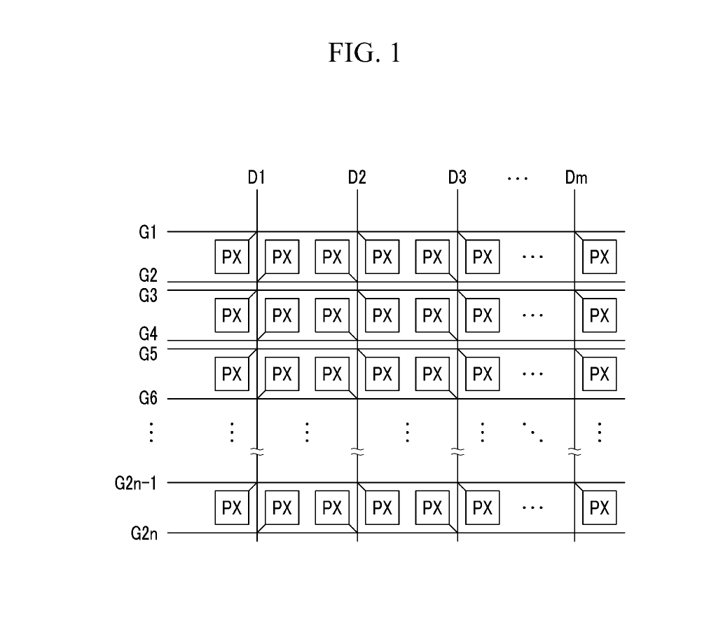

Firstly, an arrangement of a signal line and a pixel of a liquid crystal display according to an exemplary embodiment of the invention will be described with reference to FIG. 1.

FIG. 1 is a block diagram showing an arrangement of signal lines and pixels of an exemplary embodiment of a liquid crystal display according to the invention.

Referring to FIG. 1, an exemplary embodiment of a liquid crystal display according to the invention includes a plurality of display signal lines, e.g., a first to 2n-th gate lines G1 to G2n and first to m-th data lines D1 to Dm, and a plurality of pixels PX connected to the display signal lines and arranged substantially in a matrix form including a plurality of pixel rows and a plurality of pixel columns.

The display signal lines G1 to G2n and D1 to Dm include a plurality of gate lines, e.g., the first to 2n-th gate lines G1 to G2n, which transmit a gate signal (referred to as “a scanning signal”) and a plurality of data signal lines or data lines, e.g., the first to m-th data lines D1 to Dm, which transmit a data signal.

The gate lines G1 to G2n extend substantially in a first direction, e.g., a row direction or a horizontal direction, and parallel to each other, and the data lines D1 to Dm extend substantially in a second direction, e.g., a column direction or a vertical direction, and parallel to each other.

Each of pairs of gate lines G2i-1 and G2i (i=1, 2, . . . , n) are disposed opposite to each other with respect to a pixel row and are connected to the pixels PX in the pixel row, and each of the data lines Dj (j=1, 2, 3, . . . ) is disposed between two pixel columns and is connected to pixels PX in the two pixels columns at a right side and a left side thereof. In an exemplary embodiment, the pixels PX in a pixel column is connected to an adjacent data line D1 to Dm and is alternately connected to a pair of adjacent gate lines G2i-1 and G2i. The pixels PX in a pixel column are connected to a data line Dj adjacent thereto and connected to ones of the gate lines G2i-1 and G2i disposed at the same side, e.g., one of an upper side and a lower side. In one exemplary embodiment, for example, two pixels PX are disposed opposite to each other with respect to a data line D1, D2, D3, . . . and connected to the data line D1, D2, D3, . . . , and the left one of the two pixels PX is connected to an upper gate line G1, G3, G5, . . . and the right one of the two pixels PX is connected to a lower gate line G2, G4, G6, . . . In such an embodiment, a (2k-1)-th pixel (k=1, 2, . . . , m/2) in each pixel row is connected to a (2i-1)-th gate line G2i-1 and a k-th data line Dk and the 2k-th pixel is connected to a 2i-th gate line G2i and the k-th data line Dk. In an alternative exemplary embodiment, the (2k-1)-th pixel (k=1, 2, . . . , m/2) in each pixel row is connected to the 2i-th gate line G2i and the k-th data line Dk and the 2k-th pixel is connected to the (2i-1)-th gate line G2i-1 and the k-th data line Dk.

In such an embodiment, where the number of the data lines D1, D2, D3, . . . is half the number of pixel columns, the cost of the data driver is reduced, thereby reducing the manufacturing cost of the liquid crystal display.

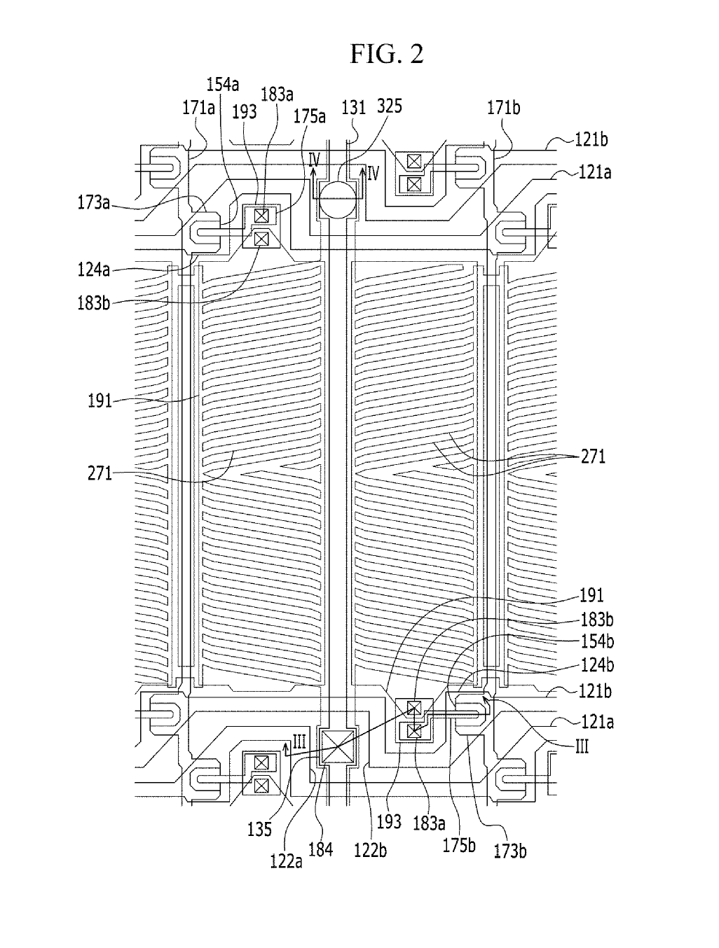

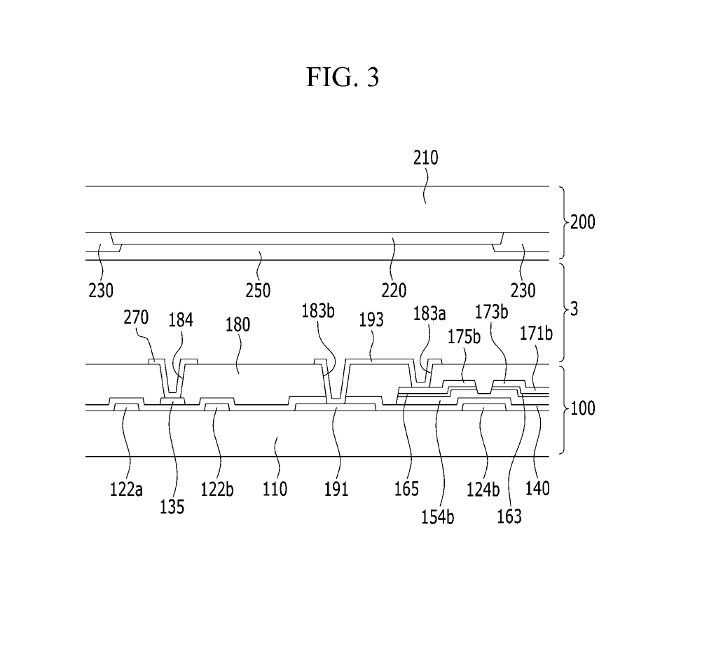

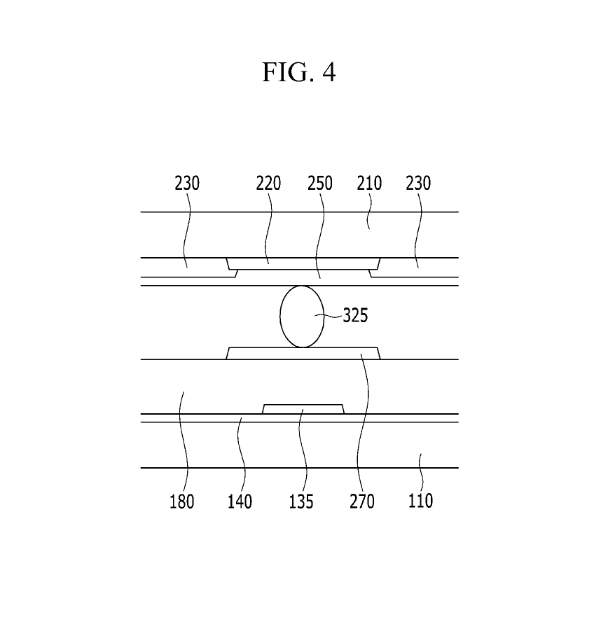

Next, an exemplary embodiment of the liquid crystal display according to the invention will be described with reference to FIG. 2 to FIG. 4. FIG. 2 is a top plan view of pixels of an exemplary embodiment of a liquid crystal display according to the invention, FIG. 3 is a cross-sectional view taken along III-III of the liquid crystal display of FIG. 2, and FIG. 4 is a cross-sectional view taken along IV-IV of the liquid crystal display of FIG. 2.

Firstly, an exemplary embodiment of the liquid crystal display according to the invention will be described with reference to FIG. 2 to FIG. 4.

Referring to FIG. 2 to FIG. 4, an exemplary embodiment of the liquid crystal display includes two display panels, e.g., a lower panel 100 and an upper panel 200, disposed opposite to each other, and a liquid crystal layer 3 interposed between the two display panels 100 and 200.

The lower panel 100 will now be described.

The lower panel 100 includes an insulation substrate 110 including transparent glass or plastic, for example. A plurality of gate lines, e.g., a first gate line 121a and a second gate line 121b, and a plurality of pixel electrodes 191 are disposed on the insulation substrate 110. As shown in FIG. 1 and FIG. 2, two gate lines 121a and 121b are disposed interposing pixels in a pixel row and include the first gate line 121a disposed at an upper side of the pixel row and a second gate line 121b disposed at a lower side of the pixel row. The first gate line 121a is disposed closer to the second gate line 121b disposed at the lower side of a previous pixel row, and the second gate line 121b is disposed closer to the first gate line 121a disposed at the upper side of a subsequent pixel row. In such an embodiment, the first gate line 121a and the second gate line 121b provided for the pixel row form a pair along with the second gate line 121 b and the first gate line 121a provided for the adjacent pixel rows, respectively, and are disposed between two pixels rows, e.g., the previous pixel row and the pixel row or the pixel row and the subsequent pixel row.

The first gate line 121a includes a first gate electrode 124a, and the second gate line 121b includes a second gate electrode 124b. The first gate line 121a includes a vertical portion 122a, and the second gate line 121b includes a vertical portion 122b.

The pixel electrode 191 may have a plane shape, which occupies substantially an entire of one pixel area. An overall shape of the pixel electrode 191 may be a polygon having edges substantially parallel to the gate lines 121a and 121b, the data line 171a or 171b, and the common voltage line 131. The pixel electrode 191 may be made of a transparent conductive material such as indium tin oxide (“ITO”) or indium zinc oxide (“IZO”).

The gate lines 121a and 121b may be disposed in the same layer as the pixel electrode 191. In an exemplary embodiment, the gate lines 121a and 121b and the pixel electrode 191 may be provided through one photolithography process using one photomask. In such an embodiment, the gate lines 121a and 121b may have a dual-layer structure including an upper layer disposed in the same layer as the pixel electrode 191.

A gate insulating layer 140 is disposed on the gate lines 121a and 121b and the pixel electrode 191. The gate insulating layer 140 may include an inorganic insulator such as silicon nitride (SiNx) or silicon oxide (SiOx), for example.

A plurality of semiconductors 154a and 154b including a first semiconductor 154a and a second semiconductor 154b is disposed on the gate insulating layer 140. In an exemplary embodiment, the semiconductors 154a and 154b may be oxide semiconductors, for example. The first semiconductor 154a and the second semiconductor 154b may be connected to each other.

A plurality of ohmic contacts 163 and 165 are disposed on the semiconductors 154a and 154b. The ohmic contacts 163 and 165 are disposed in a pair on the semiconductors 154a and 154b and opposite to each other with respect to the gate electrodes 124a and 124b. The ohmic contacts 163 and 165 may include n+hydrogenated amorphous silicon (“a-Si”) heavily doped with an N-type impurity such as phosphorous, or a silicide, for example. In an exemplary embodiment, where the semiconductors 154a and 154b include the oxide semiconductor, the ohmic contacts 163 and 165 may be omitted. In such an embodiment, where the semiconductors 154a and 154b include the oxide semiconductor, a barrier layer and a capping layer may be disposed on and under the semiconductors 154a and 154b.

A data conductor including a plurality of data lines 171a and 171b, a plurality of drain electrodes 175a and 175b, and a plurality of common voltage lines 131 are disposed on the ohmic contacts 163 and 165.

The data lines 171a and 171b, which transmit the data signal, extend substantially in the vertical direction, and crossing the gate lines 121a and 121b. The data lines 171a and 171b include a first data line 171a and a second data line 171b that are disposed opposite to each other with respect to two pixel electrodes 191 interposed therebetween.

Each of the data lines 171a and 171b are disposed at every two pixel columns, and the data lines 171a and 171b are alternately connected to the pixel electrodes 191 disposed at the left side and the right side thereof along the pixel columns corresponding thereto. As described, in such an embodiment, each of the data lines 171a and 171b are connected to the pixel electrodes 191 disposed in two pixel columns corresponding thereto, thereby applying the data voltage to the pixel electrodes 191 in two pixel columns, such that the number of data lines 171a and 171b may be half the number of pixel columns, and the cost of the liquid crystal display is thereby substantially reduced. The first data line 171a includes a first source electrode 173a extending toward the first gate electrode 124a, and the second data line 171b includes a second source electrode 173b extending toward the second gate electrode 124b.

The first drain electrode 175a includes a first end portion, which is facing the first source electrode 173a with respect to the first gate electrode 124a, and a second end having a wide area.

The second drain electrode 175b includes a first end, which is facing the second source electrode 173b with respect to the second gate electrode 124b, and a second end having a wide area.

In an exemplary embodiment of the liquid crystal display according to the invention, the gate insulating layer 140 and the data conductor is disposed on and covering the pixel electrode 191 such that that the data conductor is effectively prevented from being damaged by the etchant of the pixel electrode 191 during a process for forming the pixel electrode 191 directly on the data conductor.

The common voltage line 131 is disposed between two data lines 171a and 171b and extends substantially parallel to the data lines 171a and 171b

The common voltage line 131 includes a plurality of expansions 135. In an exemplary embodiment, an expansion 135 of the common voltage line 131 is disposed between the vertical portions 122a and 122b of the first gate line 121a and the second gate line 121b.

In such an embodiment, the expansion 135 of the common voltage line 131 is disposed between the vertical portions 122a and 122b of the first gate line 121a and the second gate line 121b such that the area occupied by the gate lines 121a and 121b and the expansion 135 of the common voltage line 131 is substantially reduced or effectively minimized.

The common voltage line 131 is disposed between two pixel electrodes 191 adjacent thereto in the pixel row direction, thereby effectively preventing light leakage between the two pixel electrodes 191.

The first and second gate electrodes 124a and 124b, the first and second source electrodes 173a and 173b, and the first and second drain electrodes 175a and 175b respectively defines a thin film transistor (“TFT”) as a switching element along with the first and second semiconductors 154a and 154b. The semiconductors 154a and 154b except for the channel region of the thin film transistor may have substantially the same plane shape as the first and second source electrodes 173a and 173b, the drain electrodes 175a and 175b, and the underlying ohmic contacts 163 and 165.

A first passivation layer 180 is disposed on the data conductors 171a, 171b, 175a, 175b, and 131 and a portion of semiconductors 154a and 154b. The first passivation layer 180 may include an inorganic insulating material or an organic insulating material, for example.

In an exemplary embodiment, where the first passivation layer 180 includes the organic material, the first passivation layer 180 may also function as a color filter 230, and in such an embodiment, the color filter 230 disposed in the upper panel 200 may be omitted.

In an exemplary embodiment, where the first passivation layer 180 is the color filter 230, the lower panel 100 may further include a second passivation layer (not shown) disposed under the first passivation layer 180 and a third passivation layer (not shown) disposed on the first passivation layer 180. In such an embodiment, the second passivation layer effectively prevents the components of the color filter 230 from being diffused to the thin film transistor, and the second passivation layer may include an inorganic insulator. The third passivation layer may have a dual-layer structure including a lower layer including the inorganic insulator and an upper layer including the organic insulator. In such an embodiment, the lower layer of the third passivation layer may effectively prevent a component of the color filter from being exposed, and the lower layer is provided at a lower temperature than the gate insulating layer 140 such that deformation and color change of the color filter 230 may be effectively prevented. In such an embodiment, the lower layer may reduce a transmittance loss according to a refractive index difference between the underlying color filter and the organic insulator. The upper layer of the third passivation layer substantially reduces a step formed by the overlapping of the color filters disposed in the neighboring pixels such that an alignment layer thereon may be uniformly rubbed and a capacitance between the data lines 171a and 171b a the common electrode 270 may be substantially reduced, thereby effectively preventing or substantially reducing a signal delay of the data lines 171a and 171b. In an alternative exemplary embodiment, the lower layer of the third passivation layer may include the organic insulator, and the upper layer of the third passivation layer may include the inorganic insulator.

In an exemplary embodiment, where the first passivation layer 180 is the color filter 230, a light blocking member 220, which is disposed in the upper panel 200 in the illustrated exemplary embodiment, may be disposed in the lower panel 100, and in such an embodiment, the light blocking member 220 disposed in the upper panel 200 may be omitted.

In an exemplary embodiment, the first passivation layer 180 may have a dual-layer structure including an inorganic insulating layer and an organic insulating layer. In such an embodiment, the organic insulator decreases the capacitance between the data lines 171a and 171b and the common electrode 270, thereby effectively preventing or substantially reducing the signal delay of the data lines 171a and 171b.

In an exemplary embodiment of the liquid crystal display according to the invention, the first passivation layer 180 is disposed on the pixel electrode 191 covered by the gate insulating layer 140 such that the deterioration of the transmittance according to a haze phenomenon of the pixel electrode 191 including ITO during a process for providing the first passivation layer 180 thereon is effectively prevented.

In an exemplary embodiment, a first contact hole 183a exposing the drain electrodes 175a and 175b may be formed through the first passivation layer 180, and a second contact hole 183b exposing a portion of the pixel electrode 191 is formed through the first passivation layer 180 and the gate insulating layer 140. A third contact hole 184 (also referred to as a “common contact hole”) exposing a portion of a plurality of expansions 135 of the common voltage line 131 is formed through the first passivation layer 180. In an alternative exemplary embodiment of the liquid crystal display according to the invention, the first contact hole 183a and the second contact hole 183b may be provided as one contact hole. In such an embodiment, one contact hole may expose the portion of the drain electrodes 175a and 175b and the portion of the pixel electrode 191.

In an exemplary embodiment of the liquid crystal display, the third contact hole 184 exposing the common voltage line 131 does not overlap the gate lines 121a and 121b. In such an embodiment, the third contact hole 184 exposing the common voltage line 131 is spaced apart from the gate line 121a and 121b such that a short of the gate lines 121a and 121b and the common voltage line 131 due to penetration of static electricity that may be generated when forming the third contact hole 184 in the gate insulating layer 140 is effectively prevented.

In such an embodiment, the expansion 135 of the common voltage line 131 does not overlap the gate lines 121a and 121b such that the step is not formed on the expansion 135 of the common voltage line 131, and the third contact hole 184 is thereby formed substantially symmetrically with a height difference according to the position. Accordingly, reliability of the electrical connection of the common voltage line 131 and the common electrode 270 through the third contact hole 184 is improved, in such an embodiment.

The common electrode 270 and a connecting member 193 are disposed on the first passivation layer 180. The common electrode 270 and the connecting member 193 may include a transparent conductive material such as ITO or IZO, for example.

The common electrode 270 includes a plurality of branch electrodes 271 and is connected to the common electrode 270 of an adjacent pixel.

The common electrode 270 is physically or electrically connected to the common voltage line 131 through the third contact hole 184 of the first passivation layer 180, thereby receiving the common voltage.

The connecting member 193 covers the first contact hole 183a exposing the portion of the drain electrodes 175a and 175b and the second contact hole 183b exposing the portion of the pixel electrode 191 such that the drain electrodes 175a and 175b and the pixel electrode 191 are physically or electrically connected to each other.

The pixel electrode 191 is electrically connected to the drain electrodes 175a and 175b through the connecting member 193, thereby receiving the data voltage.

The pixel electrode 191 applied with a data voltage generates an electric field in the liquid crystal layer 3 along with the common electrode 270 applied with the common voltage.

The branch electrodes 271 of the common electrode 270 overlap the pixel electrode 191, when viewed from a top view.

In an exemplary embodiment, a first alignment layer (not shown) may be provided on an inner surface of the lower panel 100.

Next, the upper panel 200 will be described.

The upper panel 200 includes an insulation substrate 210 including transparent glass or plastic, for example. In the upper panel 200, a light blocking member 220 is disposed on the insulation substrate 210. The light blocking member 220 is also referred to as a black matrix and effectively prevents light leakage.

A plurality of color filters 230 are provided on the insulation substrate 210 of the upper panel 200. The color filters 230 are disposed overlapping substantially an entire area of the openings enclosed by the light blocking member 230, and may extend along the column of the pixel electrodes 191 in the vertical direction. Each of the color filters 230 may display one of primary colors such as three primary colors of red, green and blue, for example. In one exemplary embodiment, for example, each of the color filters 230 may display one of three primary colors of red, green and blue, or yellow, cyan and magenta. In an alternative exemplary embodiment, the color filters may further include a color filter of a mixture of the primary colors or white.

An overcoat 250 is disposed on the color filter 230 and the light blocking member 220. The overcoat 250 may include an insulator, e.g., an organic insulator, and the overcoat 250 effectively prevents the color filter 230 from being exposed and provides a flat surface. In an alternative exemplary embodiment, the overcoat 250 may be omitted.

In an alternative exemplary embodiment, a second alignment layer (not shown) may be coated on the inner surface of the panel 200.

A spacer 325 is disposed between the lower panel 100 and the upper panel 200. The spacer 325 is disposed at a position overlapping a portion of the expansions 135 of the common voltage line 131.

The third contact hole 184 for electrically connection between the common voltage line 131 and the common electrode 270 is not formed on the portion of the expansions 135 of the common voltage line 131 overlapping the spacer 325.

In an exemplary embodiment, as described above, the common contact hole 184 for the electrical connection of the common voltage line 131 and the common electrode 270, e.g., the third contact hole 184, is not formed at the position where the spacer 325 is disposed such that the step under the spacer 325 is substantially reduced, thereby effectively stabilize the disposition of the spacer 325. In such an embodiment, the spacer 325 does not overlap the gate lines 121a and 121b such that the step of the layer under the spacer 325 is substantially reduced, thereby effectively stabilizing the disposition of the spacer 325.

In an exemplary embodiment of the liquid crystal display, the spacer 325 to maintain the interval between the lower panel 100 and the upper panel 200 is disposed at the position overlapping the expansions 135 of the common voltage line 131 such that the light leakage at the region where the spacer 325 is effectively prevented without using an additional light blocking member, thereby substantially minimizing the deterioration of the aperture ratio of the liquid crystal display.

The liquid crystal layer 3 between the lower panel 100 and the upper panel 200 includes liquid crystal molecules (not shown), and a longitudinal axis of the liquid crystal molecules is aligned substantially horizontal with respect to the surfaces of the two display panels 100 and 200 when an electric field is not generated in the liquid crystal layer 3.

The liquid crystal layer 3 may have positive dielectric anisotropy or negative dielectric anisotropy. The liquid crystal molecules of the liquid crystal layer 3 may be aligned to have a pretilt in a predetermined direction, and the pretilt direction of the liquid crystal molecules may be changed according to the dielectric anisotropy of the liquid crystal layer 3.

A backlight unit (not shown), which generates and provides light to the lower and upper display panels 100 and 200, may be disposed outside the insulation substrate 110 of the lower panel 100.

The pixel electrode 191 applied with the data voltage generates an electric field in the liquid crystal layer 3 together with the common electrode 131 applied with a common voltage, thereby determining the orientation of the liquid crystal molecules of the liquid crystal layer 3 and displaying a corresponding image.

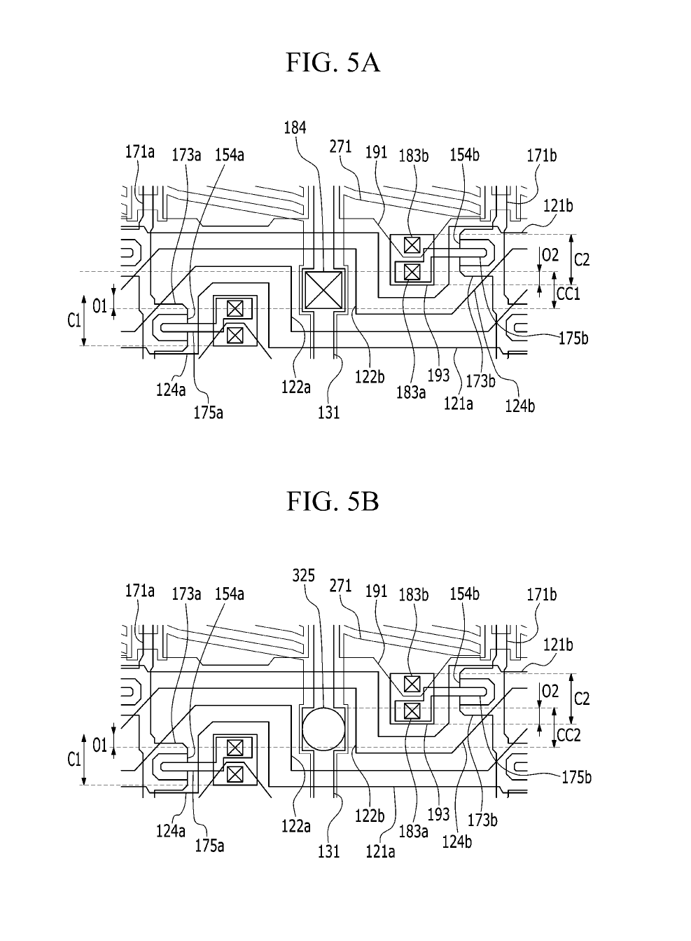

Next, referring to FIG. 5A and FIG. 5B, a relative position of the gate lines 121a and 121b, the common voltage line 131, the contact holes 183a, 183b, 184, and the spacer 325 in an exemplary embodiment of the invention will be described. FIG. 5A and FIG. 5B are top plan views of portions of an exemplary embodiment of a liquid crystal display according to the invention.

FIG. 5A is a view showing the relative position of the gate lines 121a and 121b, the common voltage line 131, and the contact holes 183a, 183b and 184, and FIG. 5B is a view showing the relative position of the gate lines 121a and 121b, the common voltage line 131, the first and second contact holes 183a and 183b, and the spacer 325.

Referring to FIG. 5A and FIG. 5B, in a plurality of pixel areas of an exemplary embodiment of the liquid crystal display, the relative position of the third contact hole 184, which electrically connects the common electrode line 131 and the common electrode 270, with respect to the gate lines 121a and 121b and the common voltage line 131 is substantially the same as the relative position of the spacer 325, which maintains the uniform cell gap between the lower and upper display panels 100 and 200, with respect to the signal lines, e.g., the gate lines 121a and 121b and the common voltage line 131. In an exemplary embodiment, one of the third contact hole 184 and the spacer 325 is provided at the position overlapping the expansion 135 of the common electrode line 131.

Each of the first gate line 121a and the second gate line 121b have the vertical portion 122a or 122b, and the expansion 135 of the common voltage line 131 is disposed between the vertical portions 122a and 122b of the first gate line 121a and the second gate line 121b adjacent thereto.

In an exemplary embodiment, a first contact portion C1 of the first drain electrode 175a and the pixel electrode 191 is disposed between the vertical portion 122a of the first gate line 121a and the first gate electrode 124a of the first gate line 121a, and a second contact portion C2 of the second drain electrode 175b and the pixel electrode 191 is disposed between the vertical portion 122b of the second gate line 121b and the second gate electrode 124b of the second gate line 121b. In such an embodiment, as described above, a third contact portion CC1 of the common voltage line 131 and the common electrode 270 or a spacer portion CC2, where the spacer is disposed, is positioned overlapping the expansion 135 of the common electrode line 131 between the vertical portion 122a of the first gate line 121a and the vertical portion 122b of the second gate line 121b.

The third contact portion CC1 of the common voltage line 131 and the common electrode 270 or the spacer portion CC2 where the spacer is disposed includes a first overlapping portion O1 where the first drain electrode 175a and the first contact portion C1 of the pixel electrode 191 are partially overlapping in the horizontal direction and a second overlapping portion O2 where the second drain electrode 175b and the second contact portion C2 of the pixel electrode are partially overlapping in the horizontal direction.

As shown in FIG. 5A and FIG. 5B, the first contact portion C1 of the first drain electrode 175a and the pixel electrode 191, and the second contact portion C2 of the second drain electrode 175b and the pixel electrode are disposed at the positions that are inversely symmetrical with reference to the third contact portion CC1 of the common voltage line 131 and the common electrode 270 or the spacer portion CC2 where the spacer is disposed.

As described, the third contact portion CC1 or the spacer portion CC2 is positioned between the vertical portions 122a and 122b of two gate lines 121a and 121b, the first contact portion C1 and the second contact portion C2 of two pixel electrodes 191 and two drain electrodes 175a and 175b that are disposed at the right side and the left side with the common voltage line 131 interposed therebetween, and the third contact portion CC1 or the spacer portion CC2 is provided to have the overlapping portions in the horizontal direction, thereby substantially reducing a vertical width of a region where two gate lines 121a and 121b and the common contact hole 184 are connected to the common voltage line 131 and the common electrode 270. In such an embodiment, two gate lines 121a and 121b and the third contact portion CC1 of the common voltage line 131 and the common electrode 270 are disposed not overlapping each other when viewed from a top view, and the deterioration of the aperture ratio of the liquid crystal display is effectively prevented.

If the third contact portion CC1 or the spacer portion CC2 is formed between the horizontal portion of two gate lines 121a and 121b, to not overlap two gate lines 121a and 121b and the third contact portion CC1 or the spacer portion CC2, the interval between the two gate lines 121 a and 121 b is wider than the vertical width of the third contact portion CC1 or the spacer portion CC2. In this case, the vertical width of the region where the two gate lines 121a and 121b and the third contact portion CC1 or the spacer portion CC2 are formed is increased, thereby the aperture ratio of the liquid crystal display may be deteriorated. In an exemplary embodiment of the liquid crystal display according to the invention, the two gate lines 121a and 121b do not overlap the third contact portion CC1 or the spacer portion CC2 when viewed from a top view such that the deterioration of the aperture ratio of the liquid crystal display is effectively prevented or substantially minimized, and the short of the common voltage line 131 and the gate line 121a and 121b according to the static electricity is effectively prevented. In an alternative exemplary embodiment of the liquid crystal display, the common contact hole 184 for the connection of the common voltage line 131 and the common electrode 270 or the spacer 325 may partially overlaps the gate lines 121a and 121b when viewed from a top view, thereby substantially reducing the interval between the two gate lines 121a and 121b.

In an exemplary embodiment, the spacer 325 is disposed at the position overlapping a portion of a plurality of expansions 135 of the common voltage line 131. In such an embodiment, the third contact hole 184 for the electrical connection between the common voltage line 131 and the common electrode 270 is not formed at the portion of the expansions 135 of the common voltage line 131 overlapping the spacer 325.

In an exemplary embodiment, an expansion 135 of the expansions 135 of the common voltage line 131 overlaps the third contact hole 184 for the electrical connection of the common voltage line 131 and the common electrode 270, and another expansion 135 of the expansions 135 overlaps the spacer 325.

In an exemplary embodiment, as described, the common contact hole 184 for the electrical connection of the common voltage line 131 and the common electrode 270 is not formed at the position where the spacer 325 is disposed such that the step under the spacer 325 is reduced, thereby substantially stabilizing the disposition of the spacer 325. In such an embodiment, the spacer 325 does not overlap the gate lines 121a and 121b such that the step under the spacer 325 is reduced, thereby substantially stabilizing the disposition of the spacer 325.

In an exemplary embodiment of the liquid crystal display, the spacer 325 that maintains the interval between the lower panel 100 and the upper panel 200 is disposed overlapping a portion of the expansions 135 of the common voltage line 131, and the light blocking member is provided at a region corresponding to the spacer 325 such that the light leakage at the region corresponding to the spacer 325 is effectively prevented without using an additional light blocking member, thereby substantially minimizing the reduction of the aperture ratio of the liquid crystal display.

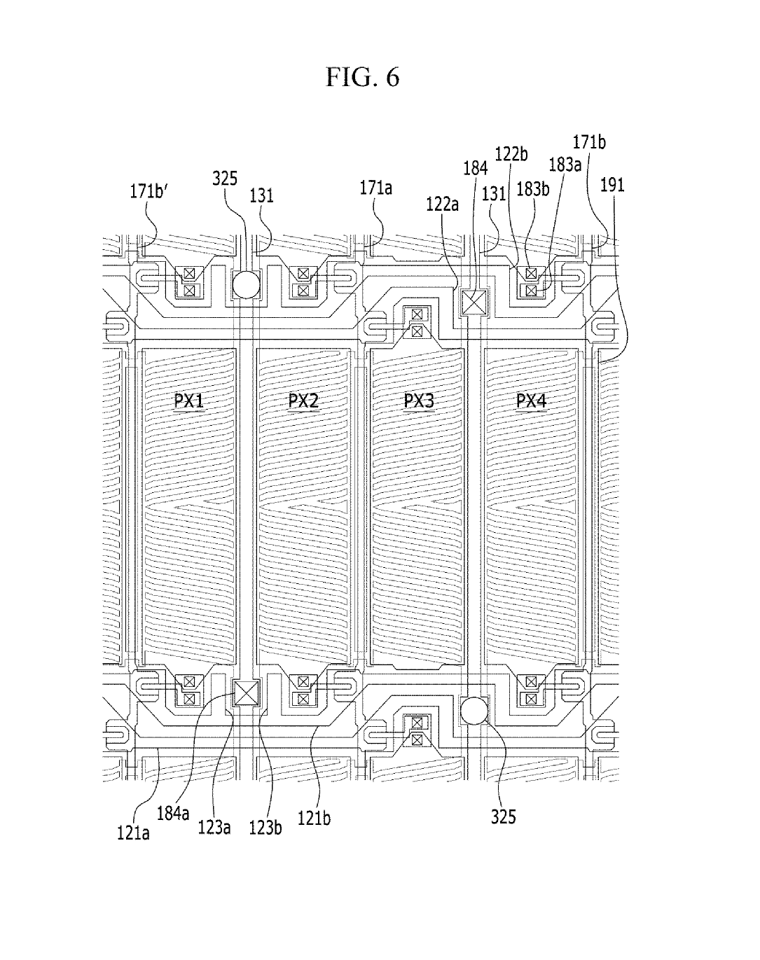

Next, an alternative exemplary embodiment of a liquid crystal display according to the invention will be described with reference to FIG. 6.

FIG. 6 is a top plan view of pixels of an alternative exemplary embodiment of a liquid crystal display according to the invention.

The liquid crystal display of FIG. 6 is substantially similar to the liquid crystal display described with reference to FIG. 2 to FIG. 4 and FIG. 5A and FIG. 5B. Particularly, the layer formation structure of each constituent element of the liquid crystal display of FIG. 6 is substantially the same as the exemplary embodiment described with reference to FIG. 2 to FIG. 4 and FIG. 5A and FIG.

5B, and any repetitive detailed description of the same constituent elements will hereinafter be omitted or simplified.

Referring to FIG. 6, an exemplary embodiment of the liquid crystal display includes two data lines, e.g., the first data line 171a and the second data line 171b disposed at the right side of the first data line (will be referred to as “right second data line”), alternately disposed corresponding to two columns of the pixel electrodes 191. In such an embodiment, another second data line 171b′ (will be referred to as a “left second data line”) may be further disposed at the left side of the first data line 171a.

In an exemplary embodiment, the pixel electrodes 191 of two pixel areas, e.g., first and second pixel areas PX1 and PX2, disposed between the first data line 171a and the left second data line 171b′ are respectively connected to two data lines 171a and 171b′ through the thin film transistors disposed on a lower side of the pixel electrode 191. In such an embodiment, the pixel electrodes 191 of two pixel areas, e.g., third and fourth pixel areas PX3 and PX4, disposed between the first data line 171a and the left second data line 171b′ are respectively connected to the two data lines 171a and 171b′ through the thin film transistors disposed at lower and upper sides of the pixel electrode 191.

The arrangement of two pixel electrodes 191, which are disposed between the right second data line 171b and the first data line 171a, and the signal lines is substantially the same as the arrangement in the exemplary embodiment of FIG. 2 to FIG. 4.

All characteristics of the liquid crystal display described with reference to FIG. 2 to FIG. 4 may be applied to the exemplary embodiment of the liquid crystal display of FIG. 6.

In an exemplary embodiment of the liquid crystal display, as shown in FIG. 6, one expansion 135 disposed in an upper portion of the common voltage line 131 disposed between the first pixel area PX1 and the second pixel area PX2 overlaps the spacer 325, and the other expansion 135 disposed in a lower portion of the common voltage line 131 overlaps the common contact hole 184 for the connection of the common voltage line 131 and the common electrode 270.

In such an embodiment, one expansion 135 disposed in an upper portion of the common voltage line 131 disposed between the third pixel area PX3 and the fourth pixel area PX4 overlaps the common contact hole 184 for the connection of the common voltage line 131 and the common electrode 270, and the other expansion 135 disposed in a lower portion of the common voltage line 131 disposed between the third pixel area PX3 and the fourth pixel area PX4 overlaps the spacer 325.

The second gate line 121b of the two gate lines 121a and 121b connected to two pixel electrodes 191 disposed between the left second data line 171b′ and the first data line 171a includes two vertical portions, e.g., a first vertical portion 123a and a second vertical portion 123b.

A fourth contact hole 184a exposing the expansion 135 of the common voltage line 131 or the spacer 325 is disposed between the two vertical portions 123a and 123b of the second gate line 121b. The connection of the common voltage line 131 and the common voltage 270 and the spacer portion are disposed between the two vertical portions 123a and 123b of the second gate line 121b and do not overlap the two gate lines 121a and 121b. In such an embodiment, each of the contact portion between the common voltage line 131 and the common electrode 270 and the spacer portion is substantially linearly disposed along with two contact portions between the pixel electrode 191 and the drain electrodes 175a and 175b.

As shown in FIG. 6, the vertical width of the region of the contact portion between two gate lines 121a and 121b and the vertical width of the region of the spacer portion between two gate lines 121a and 121b is substantially reduced such that the deterioration of the aperture ratio of the liquid crystal display is effectively prevented or substantially minimized.

In an exemplary embodiment of the liquid crystal display, an expansion 135 of the expansions 135 of the common voltage line 131 of the liquid crystal display overlaps the third contact hole 184 for the connection of the common voltage line 131 and the common electrode 270, and another expansion 135 of the expansions 135 overlaps the spacer 325. In such an embodiment, the common contact hole 184 for the electrical connection of the common voltage line 131 and the common electrode 270 is not formed at the position where the spacer 325 is disposed such that the step under the spacer 325 is reduced, thereby effectively stabilizing the disposition of the spacer 325. In such an embodiment, the spacer 325 does not overlap the gate lines 121a and 121b such that the step under the spacer 325 is reduced, thereby substantially stabilizing the disposition of the spacer 325.

In an exemplary embodiment of the liquid crystal display, the spacer 325 that maintains the interval between the lower panel 100 and the upper panel 200 is disposed at the position at an expansion of the expansions 135 of the common voltage line 131, and the light blocking member is provided at a region corresponding to the spacer 325 such that the light leakage at the region corresponding to the spacer 325 is effectively prevented, and the reduction of the aperture ratio of the liquid crystal display is thereby substantially minimized.

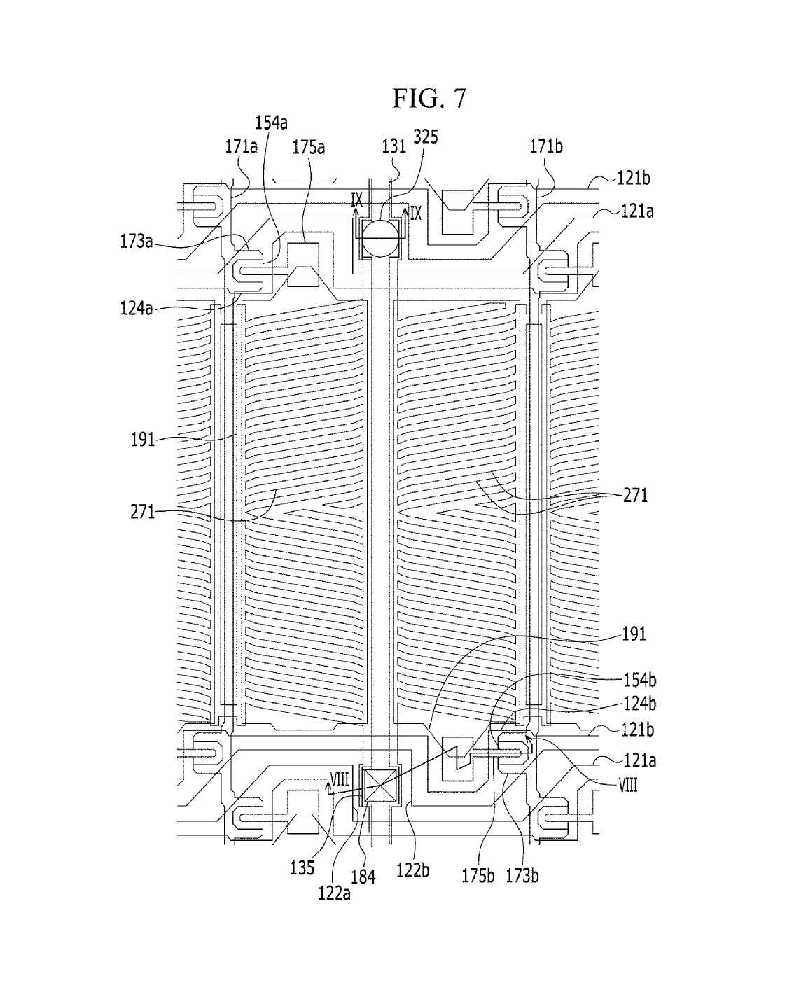

Next, another alternative exemplary embodiment f a liquid crystal display according to the invention will be described with reference to FIG. 7 to FIG. 9.

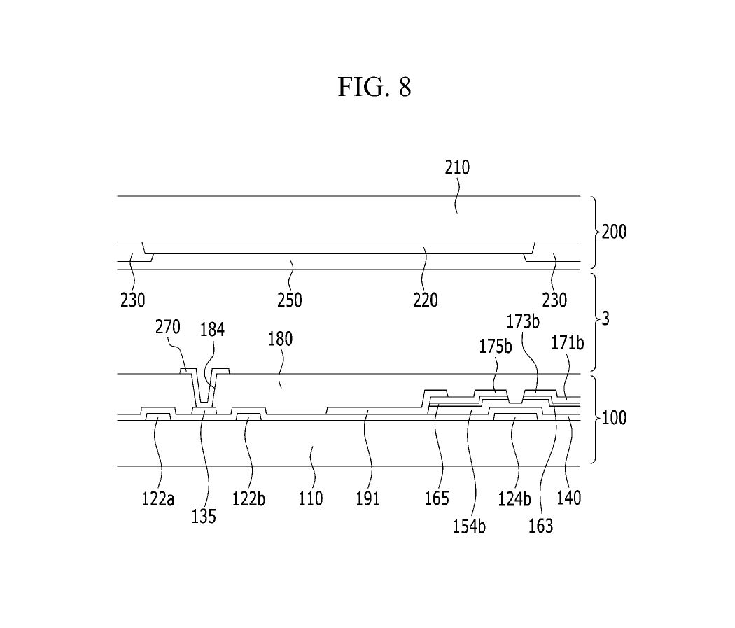

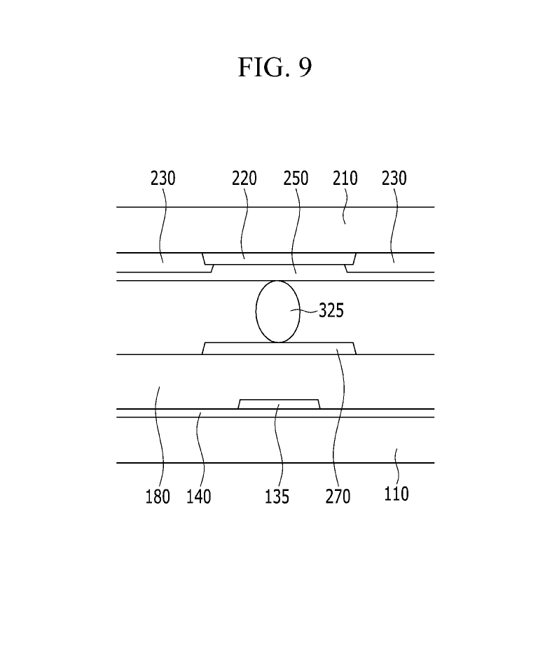

FIG. 7 is a top plan view of pixels of another exemplary embodiment of a liquid crystal display according to the invention, FIG. 8 is a cross-sectional view taken along VIII-VIII of the liquid crystal display of FIG. 7, and FIG. 9 is a cross-sectional view taken along IX-IX of the liquid crystal display of FIG. 7.

The liquid crystal display shown in FIG. 7 to FIG. 9 is substantially similar to the liquid crystal display shown in FIG. 2 to FIG. 4.

An exemplary embodiment of the liquid crystal display includes the lower panel 100 and the upper panel 200 facing each other, and the liquid crystal layer 3 disposed between the lower panel 100 and the upper panel 200.

The lower panel 100 will now be described.

The lower panel 100 includes an insulation substrate 110. A plurality of gate lines 121a and 121b are disposed on the insulation substrate 110. The gate lines 121a and 121b are provided for a pixel row and include the first gate line 121a disposed at the upper side of the pixel row and the second gate line 121b disposed at the lower side of the pixel row. The first gate line 121a is adjacent to the second gate line 121b disposed in an adjacent previous pixel row, and the second gate line 121b is adjacent to the first gate line 121a of an adjacent subsequent pixel row. In such an embodiment, each of the first gate line 121a and the second gate line 121b disposed in the upper and lower side of the pixel row is disposed between two adjacent pixel rows along with the second gate line 121b or the first gate line 121a of the adjacent previous or subsequent pixel row.

The first gate line 121a includes the first gate electrode 124a, and the second gate line 121b includes the second gate electrode 124b. The first gate line 121a includes the vertical portion 122a thereof, and the second gate line 121b includes the vertical portion 122b thereof.

A gate insulating layer 140 is disposed on the gate lines 121a and 121b.

The first semiconductor 154a and the second semiconductor 154b are formed on the gate insulating layer 140. A plurality of ohmic contacts 163 and 165 are disposed on the semiconductors 154a and 154b.

A data conductor including a plurality of data lines 171a and 171b, a plurality of drain electrodes 175a and 175b, and a plurality of common voltage lines 131 are formed on the ohmic contacts 163 and 165.

The data lines 171a and 171b transmit the data signal and mainly extend in the vertical direction thereby intersecting the gate lines 121a and 121b. The data lines 171a and 171b include the first data line 171a and the second data line 171b disposed with two pixel electrodes 191 interposed therebetween.

Each of the data lines 171a and 171b are disposed corresponding two pixel columns, and each of the data lines 171a and 171b is alternately connected to the pixel electrodes 191 disposed at the left side and the right side thereof. As described above, the data lines 171a and 171b are respectively connected to two pixel electrodes 191 disposed at two pixel columns, thereby applying the data voltage to the pixel electrodes 191 in the two pixel columns such that the number of data lines 171a and 171b is half the number of the pixel columns. Accordingly, the cost of the liquid crystal display is substantially reduced in such an embodiment.

The first data line 171a includes the first source electrode 173a extending toward the first gate electrode 124a, and the second data line 171b includes the second source electrode 173b extending toward the second gate electrode 124b.

The first drain electrode 175a includes a first end, which is opposite to the first source electrode 173a with respect to the first gate electrode 124a, and a second end having a wide area.

The second drain electrode 175b includes a first end, which is opposite to the second source electrode 173b with respect to the second gate electrode 124b, and a second end having a wide area.

The common voltage line 131 is disposed between the two data lines 171a and 171b and extends substantially parallel to the two data lines 171a and 171b. The common voltage line 131 includes a plurality of expansions 135.

An expansion 135 of the common voltage line 131 is disposed between the vertical portions 122a and 122b of the first gate line 121a and the second gate line 121b.

In such an embodiment, the expansion 135 of the common voltage line 131 is disposed between the vertical portions 122a and 122b of the first gate line 121a and the second gate line 121b such that the area occupied by the gate lines 121a and 121b and the expansion 135 of the common voltage line 131 is substantially reduced.

In an exemplary embodiment, a plurality of expansions 135 of the common voltage line 131 overlaps the common contact hole 184 or the spacer 325. In such an embodiment, each of the expansions 135 of the common voltage line 131 may overlap one of the common contact hole 184 and the spacer 325. In one exemplary embodiment, for example, an expansion 135 of the expansions 135 of the common voltage line 131 overlaps the common contact hole 184, and another expansion 135 of the expansions 135 overlaps the spacer 325.

The pixel electrode 191 is disposed on the portion of the first drain electrode 175a and the second drain electrode 175b. The pixel electrode 191 may have a plane shape corresponding to an entire of one pixel area. The overall shape of the pixel electrode 191 may be a polygon having edges substantially parallel to the gate lines 121a and 121b, the data line 171a or 171b, and the common voltage line 131. The pixel electrode 191 may include a transparent conductive material such as ITO or IZO.

In an exemplary embodiment, as shown in FIG. 7 to FIG. 9, the pixel electrode 191 may be disposed directly on the first drain electrode 175a and the second drain electrode 175b such that contact holes to connect the pixel electrode 191 and the drain electrodes 175a and 175b, e.g., the first and second contact holes 183a and 183b shown in FIG. 2 and FIG. 3, are not provided, thereby substantially increasing the aperture ratio of the liquid crystal display.

The first passivation layer 180 is disposed on the data conductors 171a, 171b, 175a, 175b and 131, an exposed portion of semiconductors 154a and 154b, and the pixel electrode 191.

In such an embodiment, the third contact hole or the common contact hole 184 exposing the expansion 135 of the common voltage line 131 is defined in, e.g., formed through, the first passivation layer 180.

In an exemplary embodiment of the liquid crystal display, the third contact hole 184 exposing the common voltage line 131 does not overlap the gate lines 121a and 121b. The expansion 135 of the common voltage line 131 corresponding to the third contact hole 184 may not overlap the gate lines 121a and 121b.

In such an embodiment, the third contact hole 184 exposing the common voltage line 131 is spaced apart from the gate lines 121a and 121b such that a short of the gate lines 121a and 121b and the common voltage line 131 due to penetration of static electricity that may occur when forming the third contact hole 184 into the gate insulating layer 140 is effectively prevented.

In such an embodiment, the expansion 135 of the common voltage line 131 does not overlap the gate lines 121a and 121b such that the step is not formed on the expansion 135 of the common voltage line 131 such that the third contact hole 184 may be symmetrically formed without a height difference according to the position. Accordingly, reliability of the electrical connection of the common voltage line 131 and the common electrode 270 through the third contact hole 184 is substantially increases in such an embodiment.

The common electrode 270 is disposed on the first passivation layer 180. The common electrode 270 includes a plurality of branch electrodes 271, and is connected to a common electrode 270 disposed in an adjacent pixel.

The common electrode 270 is physically or electrically connected to the common voltage line 131 through the third contact hole 184 of the first passivation layer 180, thereby receiving the common voltage.

The pixel electrode 191 applied with the data voltage generates an electric field in the liquid crystal layer 3 along with the common electrode 270 applied with the common voltage.

A plurality of branch electrodes 271 of the common electrode 270 overlaps the pixel electrode 191 having a plane shape.

Next, the upper panel 200 will be described.

The upper panel 200 includes an insulation substrate 210. A light blocking member 220 is disposed on the insulation substrate 210. A plurality of color filters 230 is disposed on the substrate 210. The color filters 230 may occupy substantially an entire of the openings enclosed by the light blocking member 230.

An overcoat 250 is disposed on the color filter 230 and the light blocking member 220. The overcoat 250 may include an insulator, e.g., an organic insulator, and the overcoat 250 effectively prevents the color filter 230 from being exposed and provides a flat surface. In an alternative exemplary embodiment, the overcoat 250 may be omitted.

A spacer 325 is disposed between the lower panel 100 and the upper panel 200. The spacer 325 is disposed at a position overlapping an expansion of the expansions 135 of the common voltage line 131.

The third contact hole 184 for electrical connection between the common voltage line 131 and the common electrode 270 is not disposed on the expansion 135 of the expansions 135 of the common voltage line 131 overlapping the spacer 325.

In an exemplary embodiment, the common contact hole 184 for the electrical connection of the common voltage line 131 and the common electrode 270, e.g., the third contact hole 184, is not formed at the position where the spacer 325 is disposed such that the step under the spacer 325 is substantially reduced, thereby substantially stabilizing the disposition of the spacer 325. In such an embodiment, the spacer 325 does not overlap the gate lines 121a and 121 b such that the step of the layer under the spacer 325 is not formed, thereby helping the stable disposition of the spacer 325.

In an exemplary embodiment of the liquid crystal display, each expansion of the expansions 135 of the common voltage line 131 of the liquid crystal display overlaps one of the third contact hole 184 for the electrical connection of the common voltage line 131 and the common electrode 270, and the spacer 325. In such an embodiment, the common contact hole 184 for the electric connection of the common voltage line 131 and the common electrode 270, e.g., the third contact hole 184, is not formed at the position corresponding to the spacer 325 such that the step is not formed in the layer under the spacer 325, thereby substantially stabilizing the disposition of the spacer 325. In such an embodiment, the spacer 325 does not overlap the gate lines 121a and 121b such that the step is not formed in the layer under the spacer 325, thereby substantially stabilizing the disposition of the spacer 325.

In an exemplary embodiment of the liquid crystal display, the spacer 325 that maintains the interval between the lower panel 100 and the upper panel 200 is disposed at the position overlapping the expansions 135 of the common voltage line 131 such that the light leakage at the region where the spacer 325 is effectively prevented without using an additional light blocking member, thereby substantially minimizing the deterioration of the aperture ratio of the liquid crystal display.

The liquid crystal layer 3 between the lower panel 100 and the upper panel 200 includes liquid crystal molecules (not shown), and a longitudinal axis of the liquid crystal molecules is aligned substantially horizontal with respect to the surfaces of the lower panel 100 and the upper panel 200 when an electric field is not generated in the liquid crystal layer 3.

As described above, the liquid crystal display of FIG. 7 to FIG. 9 is substantially the same as the exemplary embodiment of the liquid crystal display described with reference to FIG. 2 to FIG. 4 except that the pixel electrode is directly on the drain electrode. In such an embodiment, the pixel electrode is disposed directly on the drain electrode, the contact holes to connect the pixel electrode and the drain electrode may be omitted, thereby substantially increasing the aperture ratio of the liquid crystal display.

Other characteristics of the liquid crystal displays described with reference to FIG. 2 to FIG. 4 and FIG. 5A and FIG. 5B, or FIG. 6, may be applied to the exemplary embodiment of the liquid crystal display of FIG. 7 to FIG. 9.

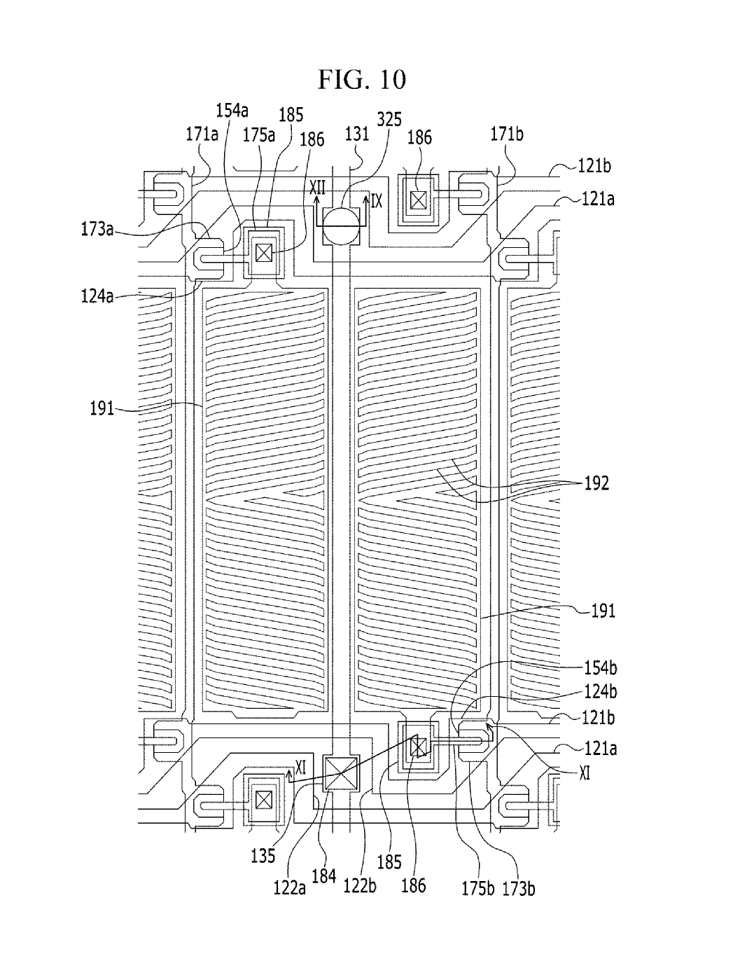

Next, another alternative exemplary embodiment of a liquid crystal display according to the invention will be described with reference to FIG. 10 to FIG. 12.

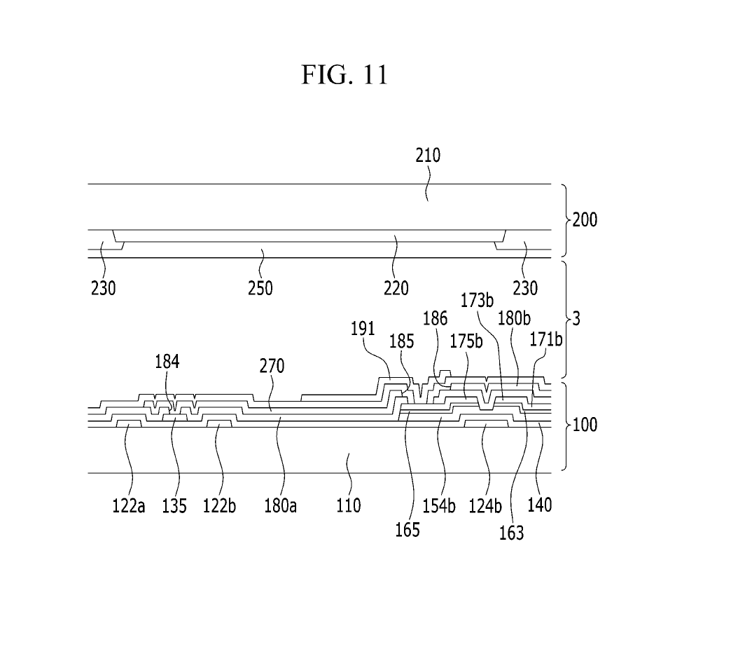

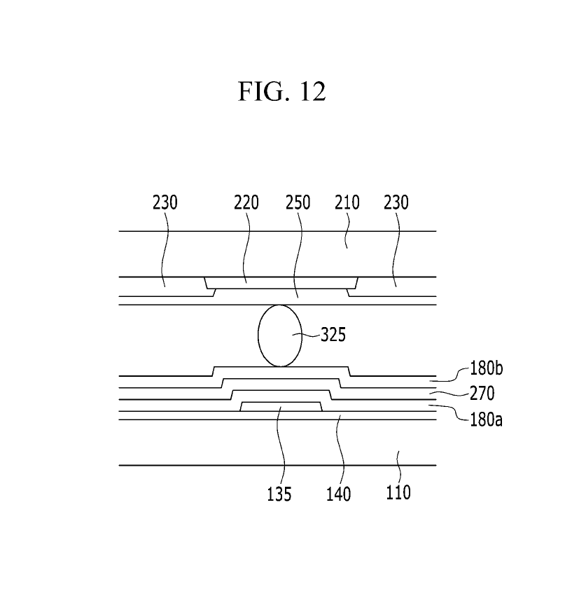

FIG. 10 is a top plan view of pixels of another alternative exemplary embodiment of a liquid crystal display according to the invention, FIG. 11 is a cross-sectional view taken along XI-XI of the liquid crystal display of FIG. 10, and FIG. 12 is a cross-sectional view taken along XII-XII of the liquid crystal display of FIG. 10.

The signal line arrangement of the liquid crystal display in FIG. 10 to FIG. 12 is similar to the signal line arrangement of the liquid crystal display of in FIG. 2 to FIG. 4 and the liquid crystal display in FIG. 7 to FIG. 9.

Referring to FIG. 10 to FIG. 12, an exemplary embodiment of the liquid crystal display includes the lower panel 100 and the upper panel 200 facing each other, and the liquid crystal layer 3 disposed between the lower panel 100 and the upper panel 200.

The lower panel 100 will now be described.

The lower panel 100 includes the insulation substrate 110. A plurality of gate lines, e.g., the first gate line 121a and the second gate line 121b, is disposed on the insulation substrate 110. In an exemplary embodiment, the gate lines 121a and 121b are provided for the pixels in a pixel row and includes the first gate line 121a disposed at the upper side of the pixel row and the second gate line 121 b disposed at the lower side of the pixel row. The first gate line 121a is adjacent to the second gate line 121b of the adjacent previous pixel row, and the second gate line 121b is adjacent to the first gate line 121a of the adjacent subsequent pixel row. In such an embodiment, each of the first gate line 121a and the second gate line 121b of the pixel row is disposed between two adjacent pixel rows along with the second gate line 121b or the first gate line 121a of the adjacent previous or subsequent pixel row.

The first gate line 121a includes the first gate electrode 124a, and the second gate line 121b includes the second gate electrode 124b. The first gate line 121a includes the vertical portion 122a, and the second gate line 121b includes the vertical portion 122b.

A gate insulating layer 140 is disposed on the gate lines 121a and 121b.

The first semiconductor 154a and the second semiconductor 154b are disposed on the gate insulating layer 140. A plurality of ohmic contacts 163 and 165 are disposed on the semiconductors 154a and 154b.

A data conductor including a plurality of data lines 171a and 171b, a plurality of drain electrodes 175a and 175b, and a plurality of common voltage lines 131 are disposed on the ohmic contacts 163 and 165.

The data lines 171a and 171b transmit the data signal and extend substantially in the vertical direction crossing the gate lines 121a and 121b. The data lines 171a and 171b include the first data line 171a and the second data line 171b disposed with two pixel electrodes 191 interposed therebetween.

Each of the data lines 171a and 171b are disposed corresponding to two pixel columns, and each of the data lines 171a and 171b is alternately connected to the pixel electrodes 191 disposed at the left side and the right side thereof. As described, the data lines 171a and 171b are respectively connected to two pixel electrodes 191 disposed at two pixel columns, thereby applying the data voltage to the pixel electrodes 191 in the two pixel columns such that the number of data lines 171a and 171b is half the number of the pixel columns. Accordingly, the cost of the liquid crystal display is substantially reduced in such an embodiment.

The first data line 171a includes the first source electrode 173a extending toward the first gate electrode 124a, and the second data line 171b includes the second source electrode 173b extending toward the second gate electrode 124b.

The first drain electrode 175a includes the first end, which is opposite to the first source electrode 173a with respect to the first gate electrode 124a, and the second end having a wide area.

The second drain electrode 175b includes the first end, which is opposite to the second source electrode 173b with respect to the second gate electrode 124b, and the second end having a wide area.

The common voltage line 131 is disposed between the two data lines 171a and 171b and extends substantially parallel to the data lines 171a and 171b. The common voltage line 131 includes a plurality of expansions 135.

The expansion 135 of the common voltage line 131 is disposed between the vertical portions 122a and 122b of the first gate line 121a and the second gate line 121b.

In such an embodiment, the expansion 135 of the common voltage line 131 is disposed between the vertical portions 122a and 122b of the first gate line 121a and the second gate line 121b such that the area occupied by the gate lines 121a and 121b and the expansion 135 of the common voltage line 131 is substantially reduced.

In an exemplary embodiment, a plurality of expansions 135 of the common voltage line 131 overlaps the common contact hole 184 or the spacer 325. In such an embodiment, each of the expansions 135 of the common voltage line 131 may overlap one of the common contact hole 184 and the spacer 325. In one exemplary embodiment, for example, an expansion 135 of the expansions 135 of the common voltage line 131 overlaps the common contact hole 184, and another expansion 135 of the expansions 135 overlaps the spacer 325.

A lower passivation layer 180a is disposed on the data conductors 171a, 171b, 175a, 175b and 131, the exposed semiconductors 154a and 154b, and the pixel electrode 191. The common electrode 270 is disposed on the lower passivation layer 180a. The common electrode 270 may have the plane shape and is connected to a common electrode 270 disposed in the adjacent pixel. The common electrode 270 may have an opening region 185 defined on the drain electrodes 175a and 175b.

An upper passivation layer 180b is disposed on the common electrode 270.

The pixel electrode 191 is disposed on the upper passivation layer 180b. The pixel electrode 191 includes a plurality of branch electrodes 192.

In such an embodiment, the third contact hole 184 exposing the expansion 135 of the common voltage line 131 is defined in the lower passivation layer 180a.

The common electrode 270 is connected to the expansion 135 of the common voltage line 131 through the third contact hole 184.

In such an embodiment, a fifth contact hole 186 is formed through the lower passivation layer 180a and the upper passivation layer 180b.

The fifth contact hole 186 is defined in a region corresponding to, e.g., overlapping, the opening region 185 of the common electrode 270.

The pixel electrode 191 contacts the drain electrodes 175a and 175b though the fifth contact hole 186 of the lower passivation layer 180a and the upper passivation layer 180b.

The pixel electrode 191 applied with the data voltage generates the electric field in the liquid crystal layer 3 along with the common electrode 270 applied with the common voltage.

In an exemplary embodiment of the liquid crystal display, the third contact hole 184 exposing the common voltage line 131 does not overlap the gate lines 121a and 121b. The expansion 135 of the common voltage line 131 corresponding to the third contact hole 184 may not overlap the gate lines 121a and 121b.

In such an embodiment, the third contact hole 184 exposing the common voltage line 131 is spaced apart from the gate lines 121a and 121b such that a short of the gate lines 121a and 121b and the common voltage line 131 due to penetration of static electricity, which may be generated when forming the third contact hole 184 into the gate insulating layer 140, is effectively prevented.

In such an embodiment, the expansion 135 of the common voltage line 131 does not overlap the gate lines 121a and 121b such that the step is not formed on the expansion 135 of the common voltage line 131 such that the third contact hole 184 may be symmetrically formed without a height difference according to the position. Accordingly, reliability of the electrical connection of the common voltage line 131 and the common electrode 270 through the third contact hole 184 substantially increases in such an embodiment.

Next, the upper panel 200 will be described.

The upper panel 200 includes an insulation substrate 210. A light blocking member 220 is disposed on the insulation substrate 210. A plurality of color filters 230 is disposed on the substrate 210. The color filters 230 may occupy substantially an entire of the openings enclosed by the light blocking member 230.

An overcoat 250 is disposed on the color filter 230 and the light blocking member 220. In an alternative exemplary embodiment, the overcoat 250 may be omitted.

A spacer 325 is disposed between the lower panel 100 and the upper panel 200. The spacer 325 is disposed at a position overlapping an expansion of the expansions 135 of the common voltage line 131.

The third contact hole 184 to electrically connect the common voltage line 131 and the common electrode 270 is not disposed on the partial expansion 135 among the plurality of expansions 135 of the common voltage line 131 overlapping the spacer 325.

In an exemplary embodiment, the common contact hole 184 for the electrical connection of the common voltage line 131 and the common electrode 270 is not formed at the position where the spacer 325 is disposed such that the step under the spacer 325 is reduced, thereby substantially stabilizing the disposition of the spacer 325. In such an embodiment, the spacer 325 does not overlap the gate lines 121a and 121b such that the step of the layer is not formed under the spacer 325, thereby substantially stabilizing the disposition of the spacer 325.

In an exemplary embodiment of the liquid crystal display, each of the expansions 135 of the common voltage line 131 of the liquid crystal display overlaps one of the third contact hole 184 for the electrical connection of the common voltage line 131 and the common electrode 270, the spacer 325. In such an embodiment, the common contact hole 184 for the electric connection of the common voltage line 131 and the common electrode 270, e.g., the third contact hole 184, is not formed at the position corresponding to the spacer 325 such that the step is not formed in the layer under the spacer 325, thereby substantially stabilizing the disposition of the spacer 325. In such an embodiment, the spacer 325 does not overlap the gate lines 121a and 121b such that the step is not formed is the layer under the spacer 325, thereby substantially stabilizing the disposition of the spacer 325.

In an exemplary embodiment of the liquid crystal display, the spacer 325 that maintains the interval between the lower panel 100 and the upper panel 200 is disposed at the position overlapping an expansion of the expansions 135 of the common voltage line 131 such that the light leakage at the region where the spacer 325 is disposed by is effectively prevented without using an additional light blocking member, thereby substantially improve the aperture ratio of the liquid crystal display.

The liquid crystal layer 3 between the lower panel 100 and the upper panel 200 includes liquid crystal molecules (not shown), and a longitudinal axis of the liquid crystal molecules may be aligned substantially horizontal with respect to the surfaces of the lower panel 100 and the upper panel 200 in the state where an electric field is not present.

As described, the exemplary embodiment of the liquid crystal display shown in FIG. 10 to FIG. 12 is similar to the exemplary embodiments described with reference to FIG. 2 to FIG. 4 and to FIG. 7 to FIG. 9 except that the exemplary embodiment of FIG. 10 to FIG. 12 includes the lower passivation layer disposed on the data conductor, the common electrode disposed on the lower passivation layer and having the plane shape, the upper passivation layer disposed on the common electrode, and the pixel electrode disposed on the upper passivation layer and including a plurality of branch electrodes.

Other characteristics of the liquid crystal displays described with reference to FIG. 2 to FIG. 4, FIG. 6 and FIG. 7 to FIG. 9 may be applied to the liquid crystal display of FIG. 10 to FIG. 12.

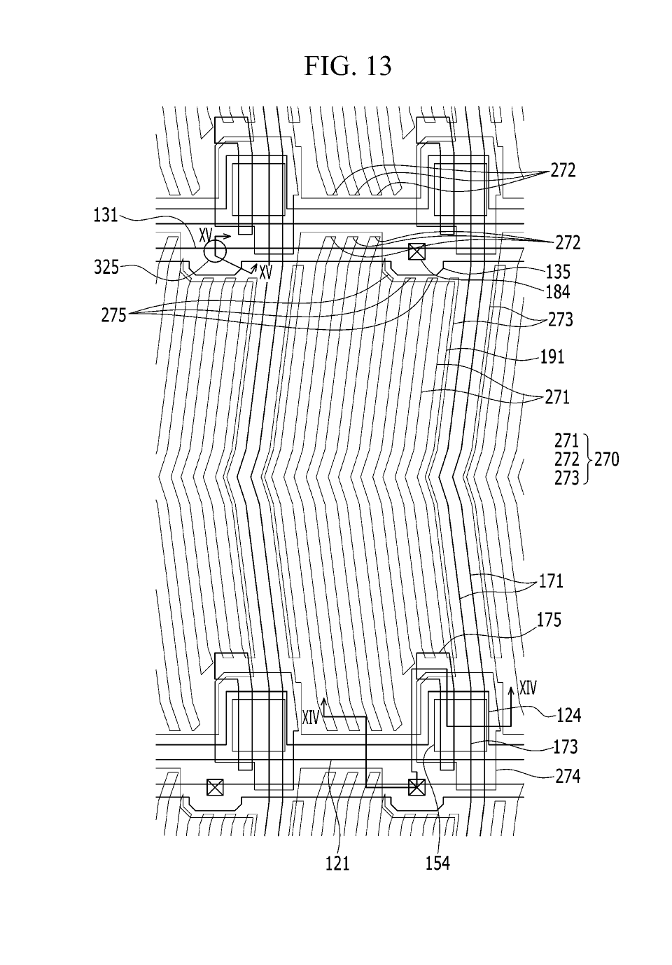

Next, another alternative exemplary embodiment of a liquid crystal display according to the invention will be described with reference to FIG. 13 to FIG. 15.

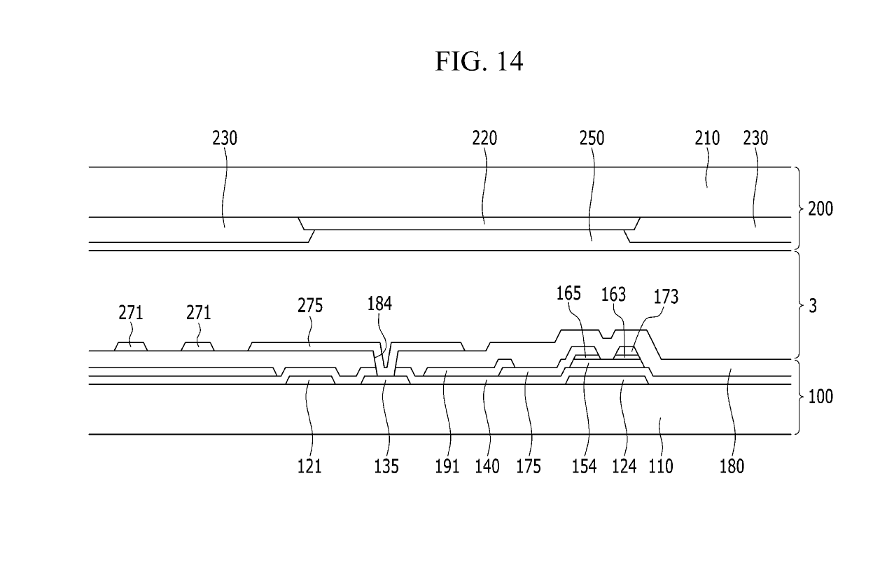

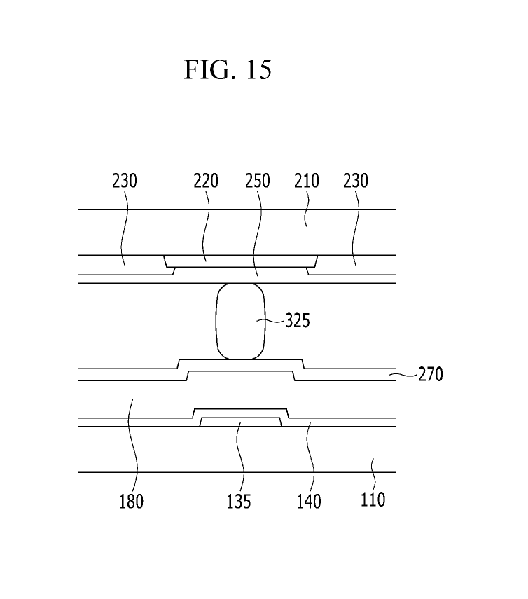

FIG. 13 is a top plan view of pixels of another alternative exemplary embodiment of a liquid crystal display according to the invention, FIG. 14 is a cross-sectional view taken along XIV-XIV of the liquid crystal display of FIG. 13, and FIG. 15 is a cross-sectional view taken along XV-XV of the liquid crystal display of FIG. 13.

Referring to FIG. 13 to FIG. 15, the liquid crystal display includes the lower panel 100 and the upper panel 200 facing each other, and the liquid crystal layer 3 interposed therebetween.

Firstly, the lower panel 100 will be described.

The lower panel 100 includes the insulation substrate 110. A gate conductor including a gate line 121 and the common voltage line 131 is disposed on the insulation substrate 110. The common voltage line 131 may be substantially parallel to the gate line 121 and disposed in the same layer as the gate line 121.

The common voltage line 131 includes a plurality of expansions 135. In an exemplary embodiment, the expansions 135 of the common voltage line 131 overlaps a common contact hole 184 or the spacer 325. In such an embodiment, each of the expansions 135 of the common voltage line 131 may overlap one of the common contact hole 184 and the spacer 325. In one exemplary embodiment, for example, an expansion 135 of the expansions 135 of the common voltage line 131 overlaps the common contact hole 184, and another expansion 135 of the expansions 135 overlaps the spacer 325.

A gate insulating layer is 140 disposed on the gate conductors 121 and 131. A plurality of semiconductors 154 is disposed on the gate insulating layer 140. Ohmic contacts 163 and 165 are disposed on the semiconductor 154. A data conductor including a data line 171 having a source electrode 173 and a drain electrode 175 is disposed on the ohmic contacts 163 and 165 and the gate insulating layer 140.

The data line 171 transmits the data signal and extends substantially in the vertical direction crossing the gate line 121. In an exemplary embodiment, the data line 171 may define the pixel area along with the gate line 121, but not being limited thereto. In such an embodiment, the data line 171 may have a first curved portion having a curved shape to obtain maximum transmittance of the liquid crystal display, and curved portions meet each other at the center region of the pixel area thereby forming a V-like shape. The center region of the pixel area may further include a second curved portion inclined with a predetermined angle with respect to the first curved portion.

The source electrode 173 is a portion of the data line 171 and is positioned on substantially the same line as the data line 171. The drain electrode 175 may be substantially parallel to the source electrode 173 such that the drain electrode 175 is substantially parallel to the portion of the data line 171.

In an exemplary embodiment, the liquid crystal display includes the source electrode 173 positioned on substantially the same line as the data line 171 and the drain electrode 175 extending parallel to the data line 171 such that the width of the thin film transistor increases without increasing the area occupied by the data conductor, thereby substantially increasing the aperture ratio of the liquid crystal display.

The pixel electrode 191 is disposed on the drain electrode 175 and the gate insulating layer 140.

The pixel electrode 191 includes a pair of curved edges substantially parallel to the first curved portion and the second curved portion of the data line 171. The pixel electrode 191 covers the portion of the drain electrode 175 and is disposed thereon, thereby being physically and electrically connected directly to the drain electrode 175.

A passivation layer 180 is formed on the data conductor 171 and 175, the exposed semiconductor 154, and the pixel electrode 191.

The passivation layer 180 and the gate insulating layer 140 have the contact hole 183 exposing the partial expansion 135 among the plurality of expansions 135 of the common voltage line 131.

A common electrode 270 is disposed on the passivation layer 180. The common electrode 270 overlaps the pixel electrode 191 and includes a plurality of branch electrodes 271, a horizontal connection 272 connecting the plurality of branch electrodes 271, and a vertical connection 273 connecting the horizontal connection 272.

The horizontal connection 272 of the common electrode 270 is substantially parallel to the gate line 121 and connects the branch electrode 271 at the upper side and the lower side of the common electrode 270. The horizontal connection 272 of the common electrode 270 disposed at a lower portion of the pixel area has a first opening 274 exposing a gate electrode 124 of the thin film transistor, the semiconductor 154, the data line 171 forming the source electrode 173, the drain electrode 175 and the portion of the common voltage line 131.

The horizontal connection 272 of the common electrode 270 has a reference electrode expansion 275 extending toward the expansion 135 of the common voltage line 131. The common electrodes 270 of adjacent pixels are connected to each other.

The horizontal connection 272 of the common electrode 270 extends along the data line 171 disposed between two adjacent pixels and may have an opening (not shown) disposed on a portion of the data line 171.

The expansion 275 of the common electrode 270 is physically or electrically connected to the common voltage line 131 through the common contact hole 184, which is formed through the passivation layer 180 and the gate insulating layer 140.

In an alternative exemplary embodiment, an alignment layer (not shown) may be coated on the reference electrode 270 and the passivation layer 180, and the alignment layer may be a horizontal alignment layer and is rubbed in a predetermined direction.

Next, the upper panel 200 will be described.

The upper panel 200 includes an insulation substrate 210. A light blocking member 220 is disposed on the insulation substrate 210. A plurality of color filters 230 is disposed on the substrate 210. The color filters 230 are disposed substantially in an area corresponding to the openings enclosed by the light blocking member 230.

An overcoat 250 is disposed on the color filter 230 and the light blocking member 220. The overcoat 250 may include an insulator, e.g., an organic insulator. The overcoat 250 effectively prevents the color filter 230 from being exposed and provides a flat surface. In an alternative exemplary embodiment, the overcoat 250 may be omitted.

A spacer 325 is disposed between the lower panel 100 and the upper panel 200. The spacer 325 is disposed at a position overlapping an expansion of the expansions 135 of the common voltage line 131. The spacer 325 is disposed on the lower panel 100 or the upper panel 200 to contact the display panels 100 and 200 facing each other. In an exemplary embodiment, the spacer 325 may include a colored material. In one exemplary embodiment, for example, the spacer 325 may have the same color as the light blocking member.

The common contact hole 184 for the electrical connection of the common voltage line 131 and the common electrode 270 is not provided on the expansion 135 overlapping the spacer 325.

In such an embodiment, the common contact hole 184 for the electrical connection of the common voltage line 131 and the common electrode 270 is not formed at the position where the spacer 325 is disposed such that the step under the spacer 325 is reduced, thereby substantially stabilizing the disposition of the spacer 325.

In an exemplary embodiment of the liquid crystal display, a plurality of expansions 135 of the common voltage line 131 overlaps the common contact hole 184 or the spacer 325. In such an embodiment, each of the expansions 135 of the common voltage line 131 may overlap one of the common contact hole 184 and the spacer 325. In one exemplary embodiment, for example, an expansion 135 of the expansions 135 of the common voltage line 131 overlaps the common contact hole 184, and another expansion 135 of the expansions 135 overlaps the spacer 325.

In an exemplary embodiment of the liquid crystal display, the spacer 325 that maintains the interval between the lower panel 100 and the upper panel 200 is disposed at the position overlapping an expansion of the expansions 135 of the common voltage line 131 such that the light leakage of the region corresponding to the spacer 325 is effectively prevented without using the additional light blocking member, thereby effectively preventing the deterioration of the aperture ratio of the liquid crystal display.

The liquid crystal layer 3 between the lower panel 100 and the upper panel 200 includes liquid crystal molecules (not shown), and a longitudinal axis of the liquid crystal molecules is aligned substantially horizontal to the surfaces of the lower panel 100 and the upper panel 200 when an electric field is not generated in the liquid crystal layer 3.

As described, the liquid crystal display of FIG. 13 to FIG. 15 is similar to the exemplary embodiment described with reference to FIG. 2 to FIG. 4 except that the liquid crystal display of FIG. 13 to FIG. 15 includes the pixel electrode formed directly on the drain electrode, and the common voltage line 131 is formed with the same layer as the gate line 121. In such an embodiment, one gate line 121 is disposed between two adjacent rows of pixels, and the data line 171 is disposed every pixel column.

In such an embodiment, the common voltage line 131 is substantially parallel to the gate line 121.

Other characteristics of the liquid crystal displays described with reference to FIG. 2 to FIG. 4, FIG. 7 to FIG. 9, and FIG. 10 to FIG. 12 may be applied to the liquid crystal display of FIG. 13 to FIG. 15.

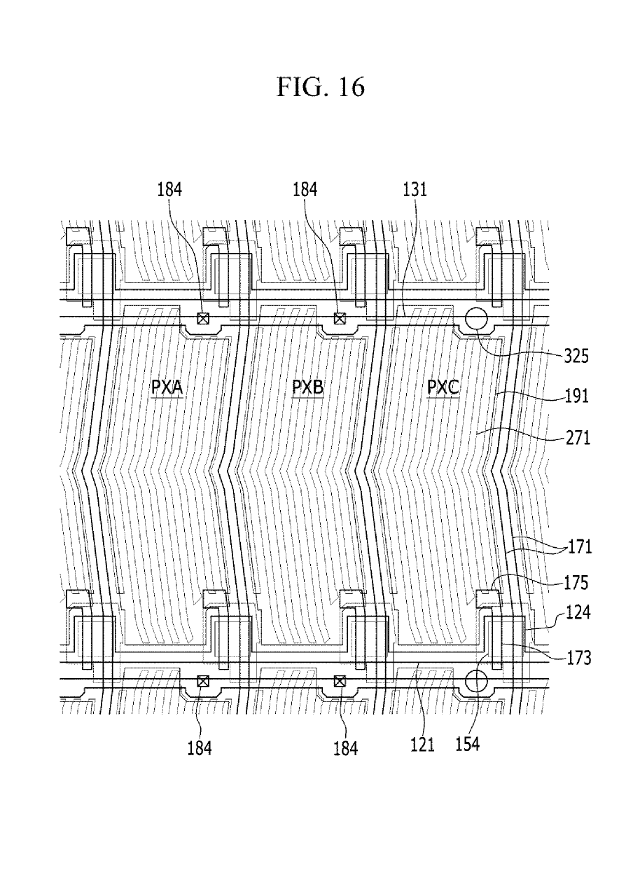

Next, areas another alternative exemplary embodiment of the liquid crystal display will be described with reference to FIG. 16.

FIG. 16 is a top plan view of pixels of another alternative exemplary embodiment of a liquid crystal display according to the invention.

Referring to FIG. 16, an exemplary embodiment of the liquid crystal display includes a plurality of pixels including at least three adjacent pixels, e.g., a first pixel PXA, a second pixel PAB and a third pixel PXC, and at least one pixel, e.g., the third pixel PXC, of the three adjacent pixels PXA, PAB and PXC includes the spacer 325.

The spacer 325 is disposed at the position corresponding to the expansion 135 of the common voltage line 131, and the common contact hole 184 for the connection of the common voltage line 131 and the common electrode 270 is not formed on the expansion 135 of the common voltage line 131 of the pixel area corresponding to the spacer 325.

In an exemplary embodiment, as shown in FIG. 16, the position of the common contact hole 184 for the connection of the common voltage line 131 and the common electrode 270 with respect to the signal lines 121, 131, and 171 and the position of the spacer 325 with respect to the signal lines 121, 131, and 171 are substantially the same as each other. In such an embodiment, in the regions of the plurality of pixels PXA, PAB and PXC, the relative position of the contact hole 183 for the connection of the common voltage line 131 and the common electrode 270 and the relative position of the spacer 325 with reference to the signal lines 121, 131, and 171 may be substantially the same as each other.

In an exemplary embodiment of the liquid crystal display, the spacer 325 that maintains the interval between the lower panel 100 and the upper panel 200 is disposed at the position overlapping an expansion 135 of expansions 135 of the common voltage line 131, e.g., an expansion 135 corresponding to the third pixel PXC, such that the light leakage at the region where the spacer 325 is disposed is effectively prevented without using an additional light blocking member, thereby effectively preventing the deterioration of the aperture ratio of the liquid crystal display.

Other characteristics of the exemplary embodiments described with reference to FIG. 1 to FIG. 15 may be applied to the liquid crystal display of FIG. 16.

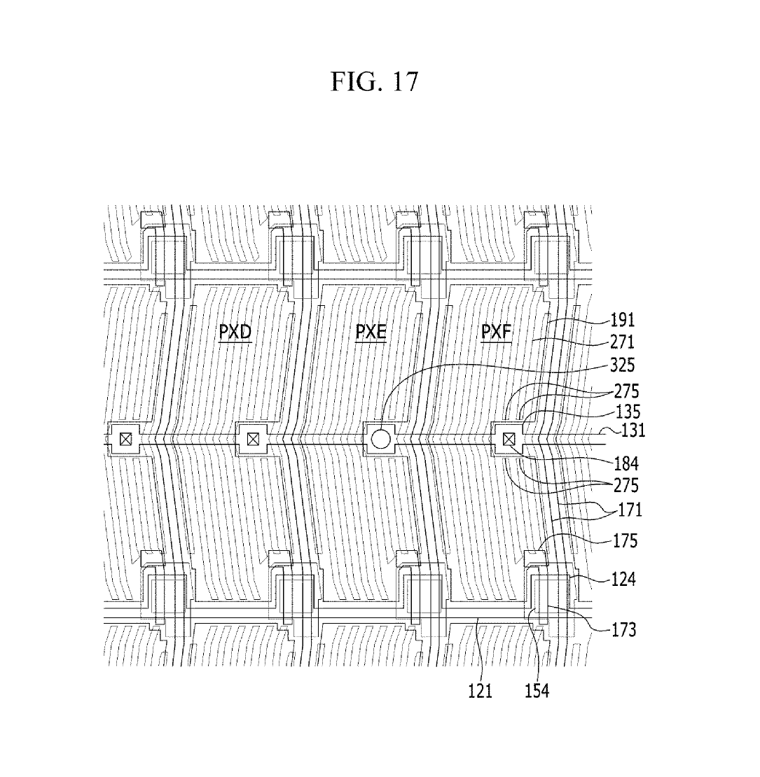

Next, another alternative exemplary embodiment of the liquid crystal display according to the invention will be described with reference to FIG. 17. FIG. 17 is a top plan view of pixels of an alternative exemplary embodiment of a liquid crystal display according to the invention.

The liquid crystal display of FIG. 17 is substantially similar to the exemplary embodiment shown in FIG. 16.

Referring to FIG. 17, an exemplary embodiment of the liquid crystal display includes a plurality of pixels including at least three adjacent pixels, e.g., a first pixel PXD, a second pixel PXE and a third pixel PXF, and at least one pixel, e.g., the second pixel PXE, of the three adjacent pixels PXD, PXE and PXF includes the spacer 325.

The spacer 325 is disposed at the position corresponding to the expansion 135 of the common voltage line 131, and the common contact hole 184 for the connection of the common voltage line 131 and the common electrode 270 is not formed on the expansion 135 of the common voltage line 131 of the pixel area corresponding to the spacer 325.

In an exemplary embodiment, as shown in FIG. 17, the position of the common contact hole 184 for the connection of the common voltage line 131 and the common electrode 270 with respect to the signal lines 121, 131, and 171 and the position of the spacer 325 with respect to the signal lines 121, 131, and 171 are disposed substantially the same as each other. In such an embodiment, in the regions of the plurality of pixels PXA, PAB, and PXC, the relative position of the common contact hole 184 for the connection of the common voltage line 131 and the common electrode 270 and the relative position of the spacer 325 with reference to the signal lines 121, 131, and 171 may be the same as each other.

In an exemplary embodiment of the liquid crystal display, as shown in FIG. 16, the common voltage line 131 transverses the center portion of the pixel area.

In an exemplary embodiment of the liquid crystal display, the spacer 325 that maintains the interval between the lower panel 100 and the upper panel 200 is disposed at the position overlapping an expansion 135 of the expansions 135 of the common voltage line 131 such that the light leakage at the region where the spacer 325 is disposed is effectively prevented without using an additional light blocking member, thereby effectively preventing the deterioration of the aperture ratio of the liquid crystal display.

Other characteristics of the liquid crystal displays of FIG. 1 to FIG. 16 may be applied to the liquid crystal display of FIG. 17.

In exemplary embodiments, the pixel electrode has the plane shape, and the common electrode has a plurality of branch electrodes or the common electrode has the plane shape and the pixel electrode has a plurality of branch electrodes, however the invention is not limited thereto. In an alternative exemplary embodiment, one of two field generating electrodes may have the plane shape and the other may have a plurality of branch electrodes. In an alternative exemplary embodiment, an additional filed generating electrode may be disposed in the upper panel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first insulation substrate;
a common voltage line disposed on the first insulation substrate and comprising a plurality of expansions;
an insulating layer disposed on the common voltage line, wherein a contact hole is defined in the insulating layer;
a common electrode disposed on the insulating layer;
a second insulation substrate disposed opposite to the first insulation substrate; and
a spacer disposed between the first insulation substrate and the second insulation substrate,
wherein each of the expansions of the common voltage line overlaps one of the contact hole and the spacer.

2. The liquid crystal display of claim 1, wherein
the common electrode is connected to the common voltage line through the contact hole.

3. The liquid crystal display of claim 2, further comprising:
a pixel electrode overlapping the common electrode when viewed from a top view.

4. The liquid crystal display of claim 3, wherein
at least one of the common electrode and the pixel electrode comprises a plurality of branch electrodes.

5. A liquid crystal display comprising:
a first insulation substrate;
a plurality of pixel electrodes disposed on the first insulation substrate substantially in a matrix form including a plurality of pixel rows and a plurality of pixel columns;
a first gate line disposed extending in a first direction;
a second gate line extending in the first direction and disposed adjacent to the first gate line, wherein the first gate line and the second gate line are disposed between two pixel electrodes in two pixel rows;
a first data line extending in a second direction;
a second data line extending in the second direction and disposed adjacent to the first data line, wherein the pixel electrodes in two pixel columns are disposed between the first data line and the second data line;
a common voltage line extending in the second direction and disposed between the two pixel columns disposed between the first data line and the second data line, wherein the common voltage line comprises a plurality of expansions;
a common electrode overlapping the pixel electrodes when viewed from a top view;
an insulating layer disposed between the common voltage line and the common electrode, wherein a common contact hole is defined in the insulating layer;
a second insulation substrate disposed opposite to the first insulation substrate; and
a spacer disposed between the first insulation substrate and the second insulation substrate,
wherein each of the expansions of the common voltage line overlaps one of the common contact hole and the spacer.

6. The liquid crystal display of claim 5, wherein
the common electrode is connected to the common voltage line through the common contact hole.

7. The liquid crystal display of claim 6, wherein
the common electrode line is dispose in a same layer as the first data line and the second data line.

8. The liquid crystal display of claim 7, wherein
the first gate line comprises a vertical portion extending therefrom substantially in the second direction,
the second gate line comprises a vertical portion extending therefrom substantially in the second direction, and
an expansion of the expansions of the common voltage line is disposed between the vertical portion of the first gate line and the vertical portion of the second vertical portion.

9. The liquid crystal display of claim 8, wherein
one of two pixel electrodes, between which the common voltage line interposed, is connected to the first drain electrode through a first drain contact hole defined in the insulating layer,
the other of the two pixel electrodes is connected to the second drain electrode through a second drain contact hole defined in the insulating layer, and
the first drain contact hole and the second drain contact hole are reversely symmetrical with reference to the spacer.

10. The liquid crystal display of claim 8, wherein
the spacer overlaps at least a portion of a first drain contact hole and a second drain contact hole when viewed from a side view in the first direction.

11. The liquid crystal display of claim 5, wherein
the common electrode line is disposed in a same layer as the first data line and the second data line.

12. The liquid crystal display of claim 11, wherein
the first gate line comprises a vertical portion extending therefrom substantially in the second direction,
the second gate line comprises a vertical portion extending therefrom substantially in the second direction, and
the expansions of the common voltage line are disposed between the vertical portion of the first gate line and the vertical portion of the second gate line.

13. The liquid crystal display of claim 12, wherein
one of two pixel electrodes, between which the common voltage line interposed, is connected to the first drain electrode through a first drain contact hole defined in the insulating layer,
the other of the two pixel electrodes is connected to the second drain electrode through a second drain contact hole defined in the insulating layer, and
the first drain contact hole and the second drain contact hole are reversely symmetrical with reference to the spacer.

14. The liquid crystal display of claim 12, wherein
the spacer overlaps at least a portion of the first drain contact hole and the second drain contact hole when viewed from a side view in the first direction.

15. The liquid crystal display of claim 5, wherein
the first gate line comprises a vertical portion extending therefrom substantially in the second direction,
the second gate line comprises a vertical portion extending therefrom substantially in the second direction, and
an expansion of the expansions of the common voltage line is disposed between the vertical portion of the first gate line and the vertical portion of the second gate line.

16. The liquid crystal display of claim 15, wherein
one of two pixel electrodes, between which the common voltage line interposed, is connected to the first drain electrode through a first drain contact hole defined in the insulating layer,
the other of the two pixel electrodes is connected to the second drain electrode through a second drain contact hole defined in the insulating layer, and
the first drain contact hole and the second drain contact hole are reversely symmetrical with reference to the spacer.

17. The liquid crystal display of claim 15, wherein
the spacer overlaps at least a portion of the first drain contact hole and the second drain contact hole when viewed from a side view in the first direction.
